(19) United States
(12) Patent Application Publication
(10) Pub. No.: US 2023/0249714 A1
(43) Pub. Date: Aug. 10, 2023

(54) VEHICLE BEHAVIOR CONTROL SYSTEM

(71) Applicant: Toyota Jidosha Kabushiki Kaisha, Toyota-shi (JP)

(72) Inventor: Shoichi SHONO, Miyoshi-shi (JP)

(73) Assignee: Toyota Jidosha Kabushiki Kaisha, Toyota-shi (JP)

(21) Appl. No.: 18/093,987

(22) Filed: Jan. 6, 2023

(30) Foreign Application Priority Data
Feb. 10, 2022 (JP) 2022-019571

(51) Int. Cl. B60W 60/00; B60W 10/20; B60W 10/22

(52) U.S. Cl. CPC B60W 60/005; B60W 10/20; B60W 10/22; B60W 2710/20; B60W 2710/22

(57) ABSTRACT

A vehicle behavior control system includes: an electric actuator mounted on a vehicle to change a posture of the vehicle; and a controller configured to control, as a control subject, one of a motion amount of the electric actuator and a force generated by the electric actuator. The controller is configured to: determine a target value of the control subject based on i) the posture that the vehicle should take, ii) a factor that causes the posture of the vehicle to be changed, or iii) both the posture that the vehicle should take and the factor that causes the posture of the vehicle to be changed; supply a current to the electric actuator based on the target value; and execute, in a specific situation, a current reduction process of reducing the current to be supplied to the electric actuator.

### CROSS REFERENCE TO RELATED APPLICATION

The present application claims priority to Japanese Patent Application No. 2022-019571, which was filed on Feb. 10, 2022, the disclosure of which is herein incorporated by reference in its entirety.

### BACKGROUND

### Technical Field

The following disclosure relates to a vehicle behavior control system for controlling a behavior of a vehicle.

### Description of Related Art

Many recently developed vehicles are equipped with a system for controlling a behavior of vehicles utilizing an electric actuator, such as a steer-by-wire steering system, an active stabilizer system, or an electromagnetic suspension system. In keeping with the trend toward electrification of vehicles, there is an increasing demand for energy saving in the vehicle behavior control systems. For instance, Japanese Patent Application Publication No. 2012-218553 describes a steering system in which power supply to the actuator is limited at an end of a steering range, namely, in the vicinity of a steering end, for achieving energy saving.

### SUMMARY

The technique described above may be effective from the viewpoint of reducing a load from a stopper at the steering end. The disclosed technique, however, is not necessarily satisfactory in terms of energy saving. That is, there remains much room for improvement in the vehicle behavior control system in terms of energy saving. Thus, the utility of the vehicle behavior control system is enhanced by making some modification to the system. Accordingly, an aspect of the present disclosure is directed to a vehicle behavior control system with high utility.

In one aspect of the present disclosure, a vehicle behavior control system, A vehicle behavior control system includes: an electric actuator mounted on a vehicle to change a posture of the vehicle; and a controller configured to control, as a control subject, one of a motion amount of the electric actuator and a force generated by the electric actuator. The controller is configured to: determine a target value of the control subject based on i) the posture that the vehicle should take, ii) a factor that causes the posture of the vehicle to be changed, or iii) both the posture that the vehicle should take and the factor that causes the posture of the vehicle to be changed; supply a current to the electric actuator based on the target value; and execute, in a specific situation, a current reduction process of reducing the current to be supplied to the electric actuator.

In the vehicle behavior control system according to the present disclosure, the current reduction process reduces a current to be supplied to the electric actuator to a greater extent in the specific situation than not in the specific situation. Thus, an energy saving effect that is high to a certain extent can be expected. Consequently, the utility of the vehicle behavior control system according to the present disclosure is enhanced.

### VARIOUS FORMS

The vehicle behavior control system to which the principle of the present disclosure is applied may include an electric actuator (hereinafter simply referred to as “actuator” where appropriate) for changing a posture of the vehicle and a controller configured to control, as a control subject, a motion amount of the actuator or a force generated by the actuator (hereinafter referred to as “actuator force” where appropriate). As long as the vehicle behavior control system includes the electric actuator and the controller, the configuration, functions, applications, etc., of the vehicle behavior control system are not limited to particular ones. The actuator may include an electric motor as a drive source. The posture of the vehicle changed by the actuator means a pitch posture (i.e., inclination of the vehicle body in the front-rear direction), a roll posture (i.e., inclination of the vehicle body in the width direction of the vehicle), a slip angle (i.e., direction and degree of turning) with respect to a traveling direction of the vehicle, etc.

Specifically, the present disclosure is applicable, for instance, to a steering system configured to steer a wheel, an active stabilizer system including a stabilizer bar to suppress a roll of the vehicle body and capable of controlling a roll suppressing force generated by the stabilizer bar, and an active suspension system configured to apply, to the vehicle body and the wheel, a force in a bound direction and a force in a rebound direction and capable of controlling the forces.

More specifically, in a case where the vehicle behavior control system of the present disclosure is the steering system, the steering system may be a system configured to assist a steering operation force of a driver utilizing a force generated by the electric actuator, i.e., what is called power steering system, or the steering system may be a system configured to steer the wheel not based on the steering operation force of the driver but based on the force generated by the actuator, i.e., what is called steer-by-wire steering system (hereinafter referred to as “steer-by-wire system” where appropriate). In the steer-by-wire system, there is a specific relationship between the motion amount of the actuator and a steering amount of the wheel. Accordingly, the control subject of the controller may be the motion amount of the actuator. The controller may obtain an operation amount of a steering operating member, such as a steering wheel, as an index of the posture that the vehicle should take, may determine a target value of the steering amount of the wheel, namely, a target value of the motion amount of the actuator, based on the operation amount, and may supply a current to the actuator based on the target value.

In a case where the vehicle behavior control system of the present disclosure is the active stabilizer system, the actuator is for changing the roll posture of the vehicle body. Specifically, in a case where the vehicle is equipped with a stabilizer bar connected at opposite ends thereof respectively to a right wheel and a left wheel to suppress the roll of the vehicle body, the actuator may be configured to change the roll suppressing force generated by the stabilizer bar. In this instance, the control subject of the controller may be the motion amount of the actuator when the roll suppressing force generated by the stabilizer bar depends on the motion amount of the actuator or may be the actuator force when the roll suppressing force generated by the stabilizer bar depends on the actuator force. The controller may obtain lateral acceleration being generated in the vehicle body, a yaw rate of the vehicle body and a vehicle traveling speed (hereinafter referred to as “vehicle speed” where appropriate), or a lateral force that acts on the vehicle body, etc., each as the factor that causes the posture of the vehicle to be changed, may determine a target value of the motion amount of the actuator or a target value of the actuator force based on the lateral acceleration, etc., and may supply a current to the actuator based on the target value.

In a case where the vehicle behavior control system of the present disclosure is the active suspension system, the actuator is for changing the pitch posture, the roll posture, a bounce posture, etc., of the vehicle body, in other words, for changing a relative distance between each wheel and the vehicle body in the up-down direction. (Hereinafter, the relative distance between each wheel and the vehicle body in the up-down direction will be referred to as “stroke amount” where appropriate). When the actuator force is designed to act directly between the wheel and the vehicle body, the actuator force may be the control subject of the controller. The actuator force may act as a damping force with respect to a relative movement of the vehicle body and the wheel or may act as a force for directly changing the stroke amount (hereinafter referred to as “stroke-amount changing force” where appropriate). Moreover, the actuator force may act as a force obtained by synthesizing the component of the damping force and the component of the stroke-amount changing force. In a case where the actuator is configured to change the pitch posture and/or the roll posture of the vehicle body, the actuator force, specifically, the stroke-amount changing component of the actuator force, may be the control subject of the controller. The controller may obtain longitudinal acceleration and/or lateral acceleration that acts on the vehicle body each as the factor that causes the posture of the vehicle to be changed, may determine a target value of the actuator force, specifically, a target value of the stroke-amount changing component of the actuator force, based on the longitudinal acceleration and/or the lateral acceleration, and may supply a current to the actuator based on the target value.

In the vehicle behavior control system of the present disclosure, the current reduction process is executed in the specific situation. The present vehicle behavior control system is configured to control the behavior of the vehicle, and the reduction in the current to be supplied to the actuator is expected to cause a reduction in the response of the system relating to the control, namely, a reduction in the response of the motion of the actuator. To put it plainly, it is expected that it takes a certain time for the motion amount of the actuator and the actuator force to reach the intended motion amount and actuator force. Thus, a situation in which a high response of the actuator is not required is regarded as the specific situation, and the current reduction process is desirably executed in such a specific situation. In view of the fact that a high response is not required for the system when the vehicle speed is low, a situation in which the vehicle speed is not higher than a set speed may be regarded as the specific situation, for instance, and the current reduction process may be executed in such a specific situation. For the vehicle capable of performing both manual driving by a driver and automated driving, a situation in which the vehicle is performing automated driving may be regarded as the specific situation considering the fact that operations that require a high response are not performed in automated driving, namely, a certain extent of extremely quick operations are not performed in automated driving. The current reduction process may be executed in such a specific situation.

While the technique of executing the current reduction process is not limited to particular one, the controller may execute the current reduction process according to the following techniques, for instance.

As explained above, the controller determines the target value of the control subject. For executing the current reduction process according to one technique, the controller may be configured to execute a low-pass filtering process on the target value only in the specific situation or the controller may be configured to lower a cutoff frequency in the low-pass filtering process executed on the target value to a greater extent in the specific situation than not in the specific situation. The low-pass filter causes a delay in the output of the target value. The low-pass filter prevents or minimizes an abrupt change of the target value. Further, the rate of change of the target value can be lowered by lowering the cutoff frequency of the low-pass filter. This technique can reduce the current to be supplied to the actuator.

The controller may be configured to supply the current to the actuator by a feedback control that is based on a deviation of an actual value of the control subject with respect to the target value of the control subject. For executing the current reduction process according to another technique in such a configuration, the controller may be configured to reduce a gain in the feedback control to a greater extent in the specific situation than not in the specific situation. This technique can reduce the current to be supplied to the actuator. The feedback control can be executed by adding up a proportional component, a differential component, and an integral component, as later described. In this instance, only gains for respectively determining the proportional component and the differential component, which components contribute to the response, may be decreased in the current reduction process.

Only one of or both the two techniques explained above may be employed in the current reduction process.

### BRIEF DESCRIPTION OF THE DRAWINGS

The objects, features, advantages, and technical and industrial significance of the present disclosure will be better understood by reading the following detailed description of embodiments, when considered in connection with the accompanying drawings, in which:

FIG. 1 is a view illustrating an overall configuration of a steering system for a vehicle, which is a vehicle behavior control system according to a first embodiment;

FIG. 2A is a view of a steering actuator of the steering system;

FIG. 2B is a cross-sectional view of a portion of the steering actuator at which a steering amount sensor is disposed;

FIG. 3 is a cross-sectional view of the steering actuator for explaining a steering motor and a motion converting mechanism;

FIG. 4A is a graph illustrating map data for determining or setting a steering gear ratio based on a vehicle speed;

FIG. 4B is a graph illustrating map data for determining or setting a cutoff frequency in a low-pass filtering process based on a vehicle speed;

FIG. 4C is a graph illustrating map data for determining or setting, based on a vehicle speed, a proportional term gain and a differential term gain utilized in determining a steering current;

FIG. 5 is a block diagram illustrating functions of a steering electronic control unit;

FIG. 6A is a graph for explaining effects of the low-pass filtering process executed on a target steering amount;

FIG. 6B is another graph for explaining the effects of the low-pass filtering process executed on the target steering amount;

FIG. 6C is still another graph for explaining the effects of the low-pass filtering process executed on the target steering amount;

FIG. 6D is yet another graph for explaining the effects of the low-pass filtering process executed on the target steering amount;

FIG. 7 is a flowchart of a steering control program executed by the steering electronic control unit;

FIG. 8 is a view of an active stabilizer system, which is a vehicle behavior control system according to a second embodiment;

FIG. 9A is a view of a front-wheel-side stabilizer device of the active stabilizer system;

FIG. 9B is a view of a rear-wheel-side stabilizer device of the active stabilizer system;

FIG. 10 is a cross-sectional view of an actuator of the stabilizer device;

FIG. 11 is a flowchart of a stabilizer control program executed by a stabilizer electronic control unit;

FIG. 12 is a view of an active suspension system, which is a vehicle behavior control system according to a third embodiment;

FIG. 13 is a view of a suspension device of the active suspension system;

FIG. 14 is a cross-sectional view of an electromagnetic actuator of the suspension device;

FIG. 15 is a cross-sectional view of a damper of the suspension device;

FIG. 16A is a conceptual view of a real device model of the suspension device;

FIG. 16B is a conceptual view of a control model of the suspension device; and

FIG. 17 is a flowchart of a suspension control program executed by a suspension electronic control unit.

### DETAILED DESCRIPTION OF THE EMBODIMENTS

Referring to the drawings, there will be described in detail a vehicle steering system according to a first embodiment of the present disclosure, an active stabilizer system according to a second embodiment of the present disclosure, and an active suspension system according to a third embodiment of the present disclosure. It is to be understood that the present disclosure is not limited to the details of the following embodiments and forms described in VARIOUS FORMS but may be changed and modified based on the knowledge of those skilled in the art.

### 1. Vehicle Steering System (First Embodiment)

There will be described a vehicle steering system (hereinafter simply referred to as “steering system” where appropriate), which is a vehicle behavior control system according to a first embodiment.

### (A) Configuration of Vehicle Steering System

### I) Overall Configuration

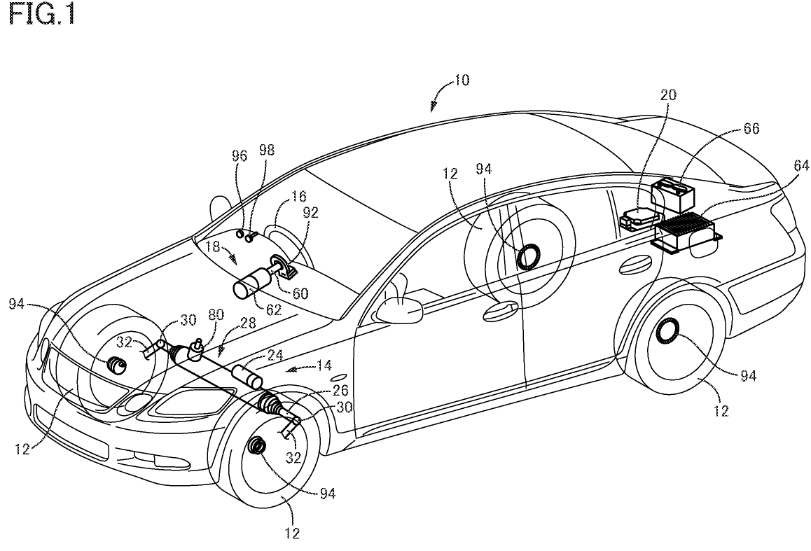

As schematically illustrated in FIG. 1, the present steering system is a steer-by-wire steering system configured to steer front right and left wheels 12 of a vehicle 10. The steering system includes: a steering device 14 configured to steer the wheels 12; an operation device 18 including a steering wheel 16, which is a steering operating member operable by a driver; and a steering electronic control unit 20 (hereinafter referred to as “steering ECU 20” where appropriate) configured to control the steering device 14 to perform steering of the wheels 12 corresponding to an operation of the steering wheel 16. The steering ECU 20 is one example of a controller.

Each wheel 12 is rotatably held by a corresponding steering knuckle (not illustrated) that is pivotably supported by a body of the vehicle via a corresponding suspension device. The steering device 14 includes: a steering actuator 28 including a steering motor 24 and configured to move a steering rod 26 in the right-left direction; link rods 32, one end of each of which is coupled to a corresponding one of opposite ends of the steering rod 26 via a ball joint 30. The steering motor 24 is an electric motor functioning as a drive source. The steering actuator 28 is one example of an electric actuator. The other end of each link rod 32 is coupled, via a ball joint (not illustrated), to a knuckle arm (not illustrated) of the corresponding steering knuckle. The steering rod 26 is moved in the right-left direction, so that the steering knuckles are pivoted to thereby steer the wheels 12.

### II) Configuration of Steering Actuator

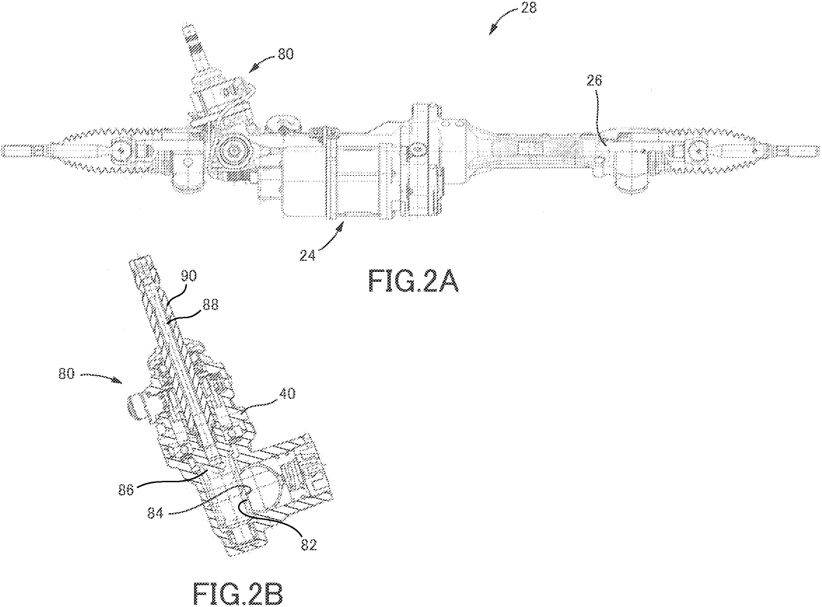

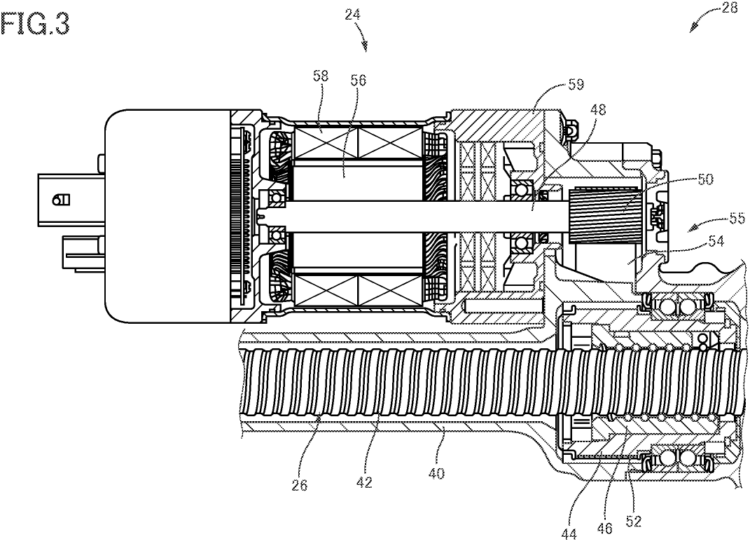

The steering actuator 28 of the steering device 14 mounted on the vehicle 10 is configured to change a posture of the vehicle 10, specifically, to change an orientation of the vehicle 10 with respect to a traveling direction of the vehicle 10, i.e., to change a slip angle of the vehicle 10. Referring also to FIGS. 2A, 2B, and 3, a basic configuration of the steering actuator 28 will be described. As apparent from FIG. 2A illustrating an overall external appearance of the steering actuator 28 and FIG. 3 illustrating an interior of the steering motor 24 and an interior of the steering actuator 28, the steering rod 26 is held in a housing 40 such that the steering rod 26 is unrotatable about the axis thereof and movable in the right-left direction. A screw groove 42 is formed on the outer circumference of the steering rod 26. A holding sleeve 44 is held in the housing 40 such that the holding sleeve 44 is rotatable about the axis thereof and immovable in the right-left direction. A nut 46 holding bearing balls is fixedly held by the holding sleeve 44. The nut 46 and the steering rod 26 are threadedly engaged with each other to constitute a ball screw mechanism. That is, a screw mechanism is constituted by a screw on the steering rod 26 and the nut 46 provided with a screw that is threadedly engaged with the screw of the steering rod 26.

The steering motor 24 is disposed outside the housing 40 such that the axis of the steering motor 24 is parallel to the axis of the steering rod 26. A timing pulley 50 is attached to one end of a motor rotational shaft 48 (hereinafter simply referred to as “motor shaft 48” where appropriate). Like the timing pulley 50, the holding sleeve 44 includes engaging teeth 52 formed on the outer circumference thereof. Thus, the holding sleeve 44 functions as another timing pulley that is paired with the timing pulley 50. A timing belt 54, which is a transmission belt, is looped over the holding sleeve 44 and the timing pulley 50. Rotation of the steering motor 24, namely, rotation of the motor shaft 48 in a strict sense, causes the nut 46 to be rotated, so that the steering rod 26 is moved rightward or leftward in accordance with the rotational direction of the steering motor 24. That is, a belt transmission mechanism is constituted by the holding sleeve 44, the timing pulley 50, and the timing belt 54. Further, a motion converting mechanism 55 is constituted by the belt transmission mechanism and the screw mechanism. The motion converting mechanism 55 is configured to convert the rotating motion of the motor shaft 48 to the motion of the steering rod 26 in a motion amount corresponding to the amount of the rotating motion of the motor shaft 48.

The steering motor 24 in the present steering system is a three-phase brushless DC motor. Specifically, magnets 56 are fixed to the outer circumference of the motor shaft 48 so as to be arranged in the circumferential direction, and coils 58 are held by a motor housing 59 of the steering motor 24 so as to be opposed to the magnets 56. The steering motor 24 is rotated by supplying a current to the coils 58. The torque generated by the steering motor 24, namely, the force that moves the steering rod 26 in the right-left direction, is generally proportional to the current supplied to the coils 58.

### III) Configuration of Operation Device

As illustrated in FIG. 1, the operation device 18 includes the steering wheel 16, a steering shaft 60 fixed to the steering wheel 16 and rotatable with the steering wheel 16, and a reaction force motor 62, which is an electric motor. The motor shaft of the reaction force motor 62 is integral with the steering shaft 60, and the reaction force motor 62 applies a rotational torque to the steering wheel 16. The rotational torque functions as a reaction force (operation reaction force) against the operation of the steering wheel 16 by the driver, i.e., the steering operation. Accordingly, the reaction force motor 62 constitutes a reaction force actuator. Though a detailed configuration of the reaction force motor 62 is not illustrated, the reaction force motor 62 is a brushless DC motor, like the steering motor 24. The operation reaction force is generated by supplying a current to the reaction force motor 62. The operation reaction force has a magnitude generally proportional to the current supplied to the reaction force motor 62. The operation reaction force functions also as a force by which the steering wheel 16 is returned to a neutral position (at which the steering wheel 16 is operated neither rightward nor leftward).

### IV) Configuration Relating to Control

The steering ECU 20 configured to control the steering system includes a computer constituted by a CPU, a ROM, a RAM, etc., and inverters each functioning as a drive circuit (driver) for a corresponding one of the steering motor 24 and the reaction force motor 62. As apparent from FIG. 1, the steering ECU 20, namely, each of the inverters of the steering ECU 20, is connected to a battery 66, which is a power source, via a converter 64. The steering ECU 20 supplies a current based on a command of the computer to each of the steering motor 24 and the reaction force motor 62.

The steering device 14 and the operation device 18 are provided with various sensors for detecting their operating states. The steering ECU 20 controls the steering system based on detection values of the sensors. Specifically, the steering actuator 28 includes a steering amount sensor 80 for detecting, as a steering amount (steering angle) θ of the wheels 12, a motion amount of the steering rod 26, namely, a motion position of the steering rod 26 in the right-left direction. FIG. 2B illustrates, in cross section, a portion of the steering actuator 28 at which the steering amount sensor 80 is disposed. As illustrated in FIG. 2B, a rack 82 is formed on the steering rod 26, and a pinion shaft 86, which includes a pinion 84 meshing with the rack 82, is held by the housing 40. The steering actuator 28 is an actuator employed in what is called power steering system. The pinion shaft 86 is connected to an input shaft 90 via a torsion bar 88. In the present steering system, the steering amount sensor 80 is disposed, in place of a torque sensor for detecting an operation torque, at a position at which the torque sensor should be disposed in the case where the steering actuator 28 is employed in the power steering system. The operation device 18 includes an operation amount sensor 92 for detecting an operation amount (operation angle) δ of the steering wheel 16. Each of the steering amount sensor 80 and the operation amount sensor 92 is what is called steering sensor having a typical configuration, a detailed description of which is dispensed with.

Each of the wheels 12 is provided with a wheel speed sensor 94 for detecting a wheel speed vw, which is a rotational speed of the corresponding wheel 12. The steering ECU 20 is configured to estimate a vehicle speed v, which is a traveling speed of the vehicle 10, based on detection values of the wheel speed sensors 94.

The vehicle 10 is capable of performing automated driving and includes an automated driving switch 96 provided on an instrument panel to perform automated driving. Further, a traveling-mode selector switch 98 is provided on the instrument panel to switch a traveling mode between an ECO mode and a sport mode. Though not described in detail, the ECO mode is a traveling mode in which fuel efficiency is prioritized while the sport mode is a traveling mode for achieving zippy driving. The traveling-mode selector switch 98 is configured to switch the traveling mode between the ECO mode and the sport mode. The automated driving switch 96 and the traveling-mode selector switch 98 are also connected to the steering ECU 20.

### (B) Control of Vehicle Steering System

In the present steering system, the steering ECU 20 functioning as the controller, namely, the computer of the steering ECU 20, executes a control for steering the wheels 12 on the steering actuator 28 to control the slip angle of the vehicle 10. (The control for steering wheels 12 will be hereinafter referred to as “steering control” where appropriate.) Further, the steering ECU 20 executes a reaction force control on the operation device 18, namely, on the reaction force motor 62 of the operation device 18, to apply, to the steering wheel 16, the operation reaction force against the steering operation by the driver. The reaction force control is a typical control. Thus, the reaction force control is not explained here. The steering control will be explained in detail.

### I) Basic Steering Control

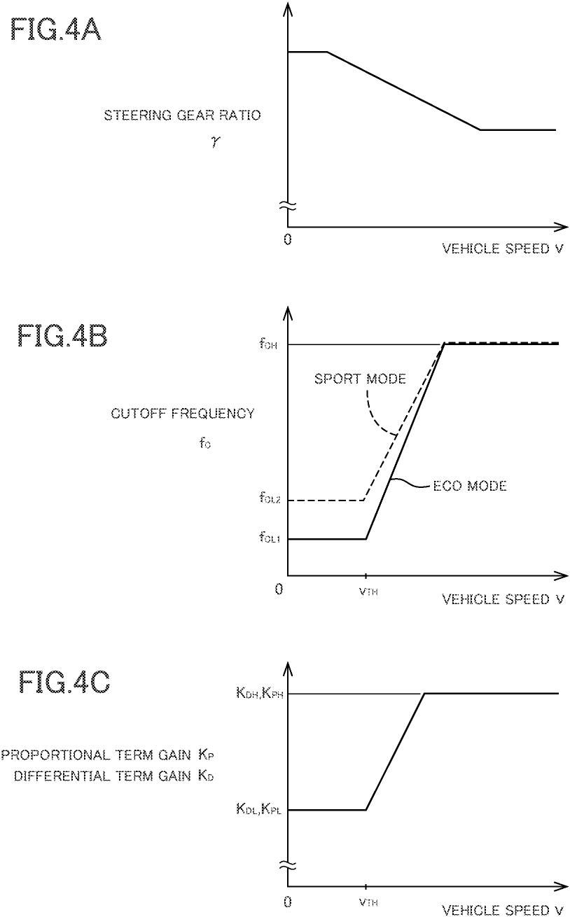

In short, the steering control is for achieving steering of the wheels 12 corresponding to a steering request. When the vehicle 10 is performing manual driving, the steering request is the operation amount δ of the steering wheel 16 detected by the operation amount sensor 92. Based on the operation amount δ, the steering ECU 20 determines a target steering amount θ*, which is a target of the steering amount θ of the wheels 12. Specifically, the present steering system employs a variable gear ratio system (VGRS). The steering ECU 20 estimates the vehicle speed v of the vehicle 10 based on the wheel speeds vw detected by the respective wheel speed sensors 94 and determines a steering gear ratio γ corresponding to the vehicle speed v. The steering gear ratio γ is a ratio of the steering amount θ with respect to the operation amount δ. The steering ECU 20 determines the steering gear ratio γ referring to map data stored in the steering ECU 20. Though not described in detail, the steering gear ratio γ is set so as to become smaller with an increase in the vehicle speed v, as illustrated in FIG. 4A. The steering ECU 20 determines the target steering amount θ* according to the following expression:

$${θ}^{\text{∗}} \text{=γ} ⋅ \text{δ}$$

When the vehicle 10 is performing automated driving triggered by turning the automated driving switch 96 on, the steering ECU 20 obtains the target steering amount θ* based on information transmitted from an automated driving electronic control unit (not illustrated). The automated driving electronic control unit will be hereinafter referred to as “automated driving ECU” where appropriate.

The steering amount θ can be considered as the motion amount of the steering rod 26 in the right-left direction, namely, the motion amount of the steering actuator 28. The motion amount of the steering actuator 28 is a control subject in the steering control executed in the present steering system. Thus, the target steering amount 0* is a target value of the control subject. In the present steering system, the target steering amount θ* is defined as a rotational amount (rotational position) of the pinion shaft 86 of the steering actuator 28.

The steering ECU 20 detects, as an actual value of the control subject, an actual steering amount θ via the steering amount sensor 80 of the steering actuator 28. The steering ECU 20 determines a steering amount deviation Δθ, which is a deviation of the actual steering amount θ with respect to the target steering amount θ*. Based on the steering amount deviation Δθ, the steering ECU 20 determines a current I_{S} to be supplied to the steering motor 24 (hereinafter referred to as “steering current I_{S}” where appropriate) according to a feedback control technique. Specifically, the steering ECU 20 determines the steering current I_{S} according to the following expression:

$${\text{I}}_{\text{s}} = {\text{K}}_{\text{P}} ⋅ Δ \text{θ} {\text{+K}}_{\text{D}} ⋅ \text{d} Δ \text{θ} / {\text{dt+K}}_{\text{I}} ⋅ \int Δ \text{θ} \text{dt}$$

The first term, the second term, and the third term on the right side of the expression are a proportional component, a differential component, and an integral component, respectively, and “K_{P}”, “K_{D}”, and “K_{I}” are a proportional term gain, a differential term gain, and an integral term gain, respectively. The steering ECU 20 supplies the current to the steering motor 24 via the inverter based on the steering current I_{S} determined as described above.

### II) Current Reduction Process

In the present steering system, a current reduction process for reducing a current to be supplied to the steering actuator 28 is executed in a specific situation in consideration of power and energy saving. The current reduction process will be hereinafter described.

When the current to be supplied to the steering actuator 28 is reduced, a force generated by the steering actuator 28 (hereinafter referred to as “actuator force” where appropriate) is decreased, resulting in a delay of the motion of the steering actuator 28. That is, the response of the steering actuator 28 is lowered. Specifically, the decrease of the actuator force may cause a possibility that a change in the actual steering amount θ does not follow a change in the target steering amount θ* in steering of the wheels 12. The possibility is high when the change in the target steering amount θ* is large, in other words, when a relatively abrupt steering operation is performed or when a relatively large actuator force is required.

In the present steering system, therefore, the specific situation in which the current reduction process is executed is limited to a situation in which high response is not required for the motion of the electric actuator. When the vehicle speed v is high, for instance, the self-aligning torque that acts on the wheels 12 being steered is large, thus requiring a relatively large actuator force. Further, when the vehicle speed v is high, the response that is high to a certain extent is required in terms of a driving feeling and a driving stability of the vehicle 10, for instance. In view of these facts, the steering ECU 20 identifies that the vehicle 10 is in the specific situation and executes the current reduction process when the vehicle speed v is low, namely, when the vehicle speed v is not higher than a threshold vehicle speed v_{TH}, e.g., 20-30 km/h.

The steering ECU 20 of the present steering system executes two current reduction processes that are mutually different in technique. One of the two current reduction processes is a low-pass filtering process (hereinafter simply referred to as “filtering process” where appropriate) executed on the target steering amount 0*. Specifically, the steering ECU 20 executes, on the target steering amount 0* determined as described above, a process of prohibiting a change of the target steering amount θ* that has a frequency higher than a cutoff frequency f_{C}, in other words, a process of causing a delay in a change of the target steering amount θ* that has a frequency higher than the cutoff frequency f_{C}. As illustrated in the graph of FIG. 4B, when the vehicle speed v is not higher than the threshold vehicle speed v_{TH}, the cutoff frequency f_{C} is set to a low frequency f_{CL}, which is relatively low. As described above, the two traveling modes are set for the vehicle 10, one of which is the ECO mode that emphasizes energy saving and the other of which is the sport mode that emphasizes the vehicle driving performance. In the graph, a change of the cutoff frequency f_{C} in the ECO mode is indicated by the solid line, and a change of the cutoff frequency f_{C} in the sport mode is indicated by the dashed line. As apparent from the graph, a low frequency f_{CL1} is set as the low frequency f_{CL} in the ECO mode, and a low frequency f_{CL2} (>f_{CL1}) is set as the low frequency f_{CL} in the sport mode, in consideration of a difference between the two modes in the level of the response required. As illustrated in the graph, the cutoff frequency f_{C} is set, in either of the two traveling modes, so as to gradually become high with an increase in the vehicle speed v exceeding the threshold vehicle speed v_{TH}. When the vehicle speed v becomes higher than or equal to a certain speed, the cutoff frequency f_{C} is set to a high frequency f_{CR}. In this respect, the low frequency f_{CL1} is about 5 Hz, the low frequency f_{CL2} is about 10 Hz, and the high frequency f_{CH} is about 30 Hz, for instance.

The other of the two current reduction processes is a process of reducing the proportional term gain K_{P} and the differential term gain K_{D} in the determination of the steering current I_{S} according to the feedback control technique described above. This process will be hereinafter referred to as “gain reduction process” where appropriate. As illustrated in the graph of FIG. 4C, the proportional term gain K_{P} and the differential term gain K_{D}, which relate to the response, are respectively set to a low gain K_{PL} and a low gain K_{DL} when the vehicle speed v is not higher than the threshold vehicle speed v_{TH}. The proportional term gain K_{P} and the differential term gain K_{D} are set so as to gradually increase with an increase in the vehicle speed v exceeding the threshold vehicle speed v_{TH}. When the vehicle speed v becomes higher than or equal to a certain speed, the proportional term gain K_{P} and the differential term gain K_{D} are respectively set to a high gain K_{PH} and a high gain K_{DH}.

As described above, the vehicle 10 is capable of performing both manual driving and automated driving. Thus, when the vehicle 10 is performing automated driving, the steering ECU 20 regards that the vehicle 10 is in the specific situation and executes the current reduction process, irrespective of the vehicle speed v.

In manual driving, the cutoff frequency f_{C} in the filtering process and the proportional term gain K_{P} and the differential term gain K_{D} utilized in determining the steering current I_{S} are set in dependence on the vehicle speed v. In contrast, in automated driving, the cutoff frequency f_{C} is set to the low frequency f_{CL1}, and the proportional term gain K_{P} and the differential term gain K_{D} are respectively set to the low gain K_{PL} and the low gain K_{DL}, irrespective of the vehicle speed v.

In the present steering system, the filtering process is executed on the target steering amount θ* also when the vehicle 10 is not in the specific situation. The filtering process may be configured not to be executed when the vehicle 10 is not in the specific situation. In the present steering system, when the vehicle speed v exceeds the threshold vehicle speed v_{TH}, i) the cutoff frequency f_{C} in the filtering process is set so as to gradually increase from the low frequency f_{CL} to the high frequency f_{CH} in dependence on the vehicle speed v and ii) the proportional term gain K_{P} and the differential term gain K_{D} are set so as to gradually increase respectively from the low gain K_{PL}, the low gain K_{DL} to the high gain K_{PH}, the high gain K_{DH} in dependence on the vehicle speed v. The cutoff frequency f_{C}, the proportional term gain K_{P}, and the differential term gain K_{D} may be set otherwise. For instance, when the vehicle speed v exceeds the threshold vehicle speed v_{TH}, the cutoff frequency f_{C}, the proportional term gain K_{P}, and the differential term gain K_{D} may be increased stepwise, so as to be set to the high frequency f_{CH}, the high gain K_{PH}, and the high gain K_{DH}, respectively. In the current reduction process executed in the present steering system, the steering ECU 20 changes both of: i) the cutoff frequency f_{C} in the filtering process; and ii) the two gains utilized in determining the steering current I_{S}, i.e., the proportional term gain K_{P} and the differential term gain K_{D}. Only one of: i) the cutoff frequency f_{C} and ii) the two gains K_{P}, K_{D} may be changed.

### III) Functional Block Diagram Relating to Steering Control

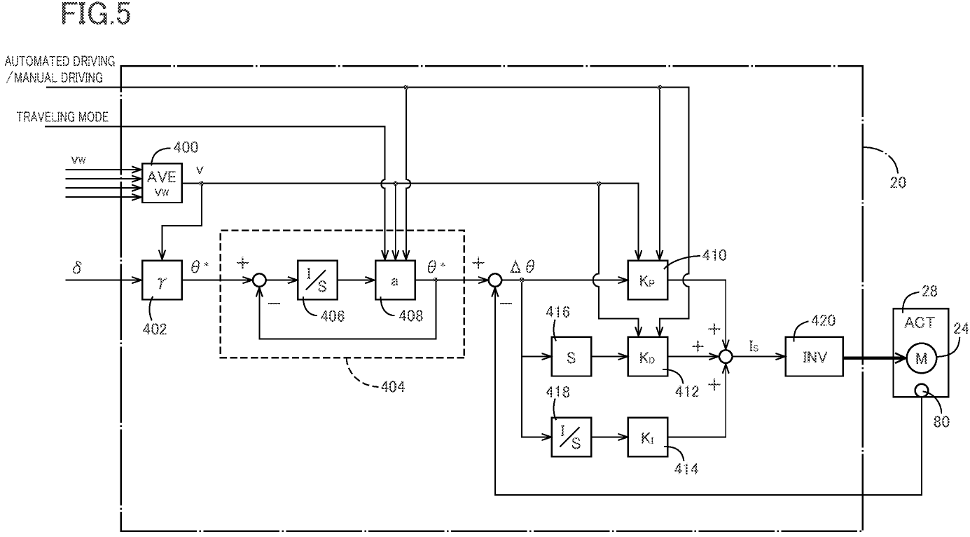

FIG. 5 is a block diagram illustrating functions of the steering ECU 20 involved in the steering control that includes the current reduction process described above. The steering ECU 20 includes a vehicle-speed estimating portion 400 configured to estimate the vehicle speed v of the vehicle 10 based on the wheel speeds vw of the respective four wheels 12 detected by the corresponding wheel speed sensors 94. The steering ECU 20 further includes a target steering-amount determining portion 402 configured to determine, based on the vehicle speed v, the steering gear ratio γ referring to the map data illustrated in FIG. 4A and to determine the target steering amount θ* based on the steering gear ratio γ and the operation amount δ of the steering wheel 16 detected by the operation amount sensor 92.

The steering ECU 20 further includes a low-pass filter 404 configured to execute the low-pass filtering process on the target steering amount θ* determined by the target steering-amount determining portion 402. The low-pass filter 404 has a typical configuration and will be simply described. The low-pass filter 404 includes an integral element 406 and a proportional element 408. The character “a” in the proportional element 408 illustrated in FIG. 5 is defined by the following expression:

$$\begin{matrix}\text{a} = 1 / \text{T} & \left(\text{T: time constant}\right)\end{matrix}$$

A transfer function G(s) of the low-pass filter 404 is represented as follows:

$$\begin{matrix}\text{G} \left(\text{s}\right) = 1 / \left(\text{1+T} ⋅ \text{s}\right) & \left(\text{s: Laplace operator}\right)\end{matrix}$$

Further, the relationship between the time constant T and the cutoff frequency f_{C} is represented as follows:

$$\text{T=} 1 / \left(2 ⋅ \text{π} ⋅ {\text{f}}_{\text{C}}\right)$$

The low-pass filter 404 sets the cutoff frequency f_{C} depending on the traveling mode and depending on whether the vehicle 10 is performing automated driving or manual driving. When the vehicle 10 is performing manual driving, the low-pass filter 404 sets the cutoff frequency f_{C} based on the estimated vehicle speed v while referring to the map data of FIG. 4B. When the vehicle 10 is performing automated driving, the low-pass filter 404 sets the cutoff frequency f_{C} to the low frequency f_{CL1} irrespective of the vehicle speed v. Based on the thus set cutoff frequency f_{C}, the low-pass filter 404 determines the time constant T and executes the filtering process.

The steering ECU 20 determines a steering amount deviation Δθ, which is a deviation of the actual steering amount θ detected by the steering amount sensor 80 of the actuator 28 with respect to the target steering amount θ* on which the filtering process has been executed. The steering ECU 20 includes a proportional-term-gain multiplier 410, a differential-term-gain multiplier 412, an integral-term-gain multiplier 414, a differentiator 416, and an integrator 418. Based on the steering amount deviation Δθ, the steering ECU 20 determines a proportional component of the steering current I_{S} via the proportional-term-gain multiplier 410, determines a differential component of the steering current I_{S} via the differentiator 416 and the differential-term-gain multiplier 412, and determines an integral component of the steering current I_{S} via the integrator 418 and the integral-term-gain multiplier 414. The steering ECU 20 adds up the proportional component, the differential component, and the integral component to thereby determine the steering current S. The steering ECU 20 determines the proportional component and the differential component depending on whether the vehicle 10 is performing automated driving or manual driving. When the vehicle 10 is performing manual driving, the steering ECU 20 determines the proportional term gain K_{P} and the differential term gain K_{D} based on the estimated vehicle speed v referring to the map data of FIG. 4C. When the vehicle 10 is performing automated driving, the steering ECU 20 sets the proportional term gain K_{P} and the differential term gain K_{D} respectively to the low gain K_{PL} and the low gain K_{DL}. The command as to the determined steering current I_{S} is transmitted to the inverter 420, and the inverter 420 supplies the thus determined steering current I_{S} to the steering motor 24 of the actuator 28.

### IV) Effects Provided by Current Reduction Process

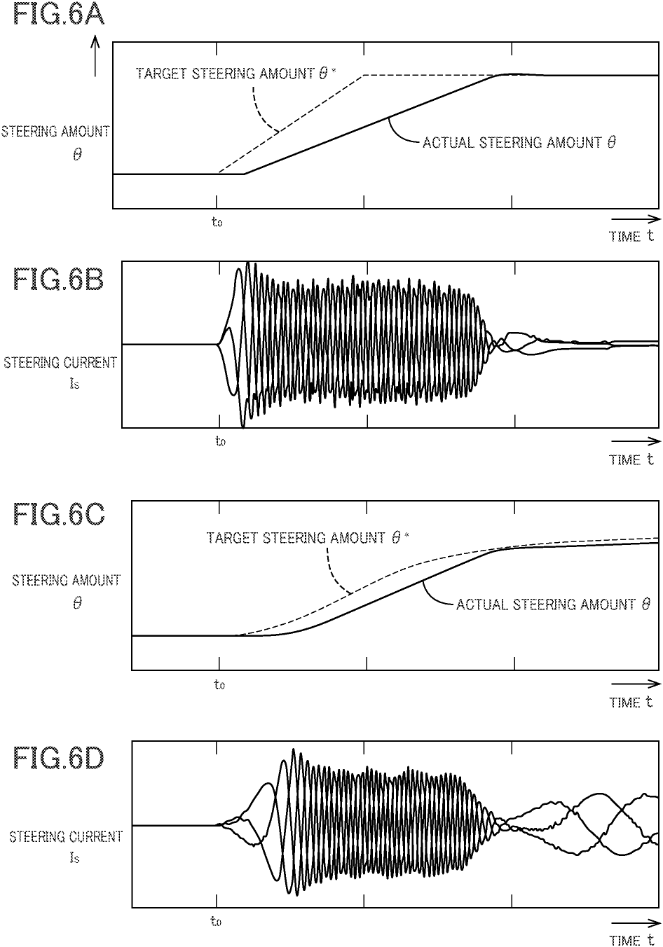

Referring next to FIGS. 6A-6D, there will be described effects provided by the current reduction process, namely, effects provided by the low-pass filtering process executed on the target steering amount θ*. The graphs of FIGS. 6A and 6B respectively illustrate changes of the target steering amount 0* and the actual steering amount θ with respect to a lapse of a time t and a change of the steering current I_{S} with respect to a lapse of time t, in a case where the filtering process is not executed. The graphs of FIGS. 6C and 6D respectively illustrate changes of the target steering amount 0* and the actual steering amount θ with respect to a lapse of a time t and a change of the steering current I_{S} with respect to a lapse of a time t, in a case where the filtering process is executed. The cutoff frequency f_{C} in the filtering process is set at 5 Hz. The steering conditions such as the vehicle speed v, the operation amount δ of the steering wheel 16, and an operation speed dδ/dt of the steering wheel 16 are the same between the case where the filtering process is executed and the case where the filtering process is not executed. The operation of the steering wheel 16 is initiated at a time t₀. The steering motor 24 is a three-phase brushless motor. The steering current I_{S} represents a current of the U phase, a current of the V phase, and a current of the W phase of the steering motor 24.

As apparent from the graph of FIG. 6A, in the case where the filtering process is not executed, the gradient of increase in the target steering amount θ* is relatively steep, and the actual steering amount θ does not follow the target steering amount θ* adequately. As apparent from the graph of FIG. 6C, in the case where the filtering process is executed, the gradient of increase in the target steering amount θ* is relatively gentle, and the actual steering amount θ follows the target steering amount θ* relatively adequately. As is understood from comparison between the graph of FIG. 6B and the graph of FIG. 6D, the amplitude of the current of each phase is smaller in the case where the filtering process is executed than the case where the filtering process is not executed. That is, the steering current I_{S} is reduced by executing the filtering process.

### V) Control Flow

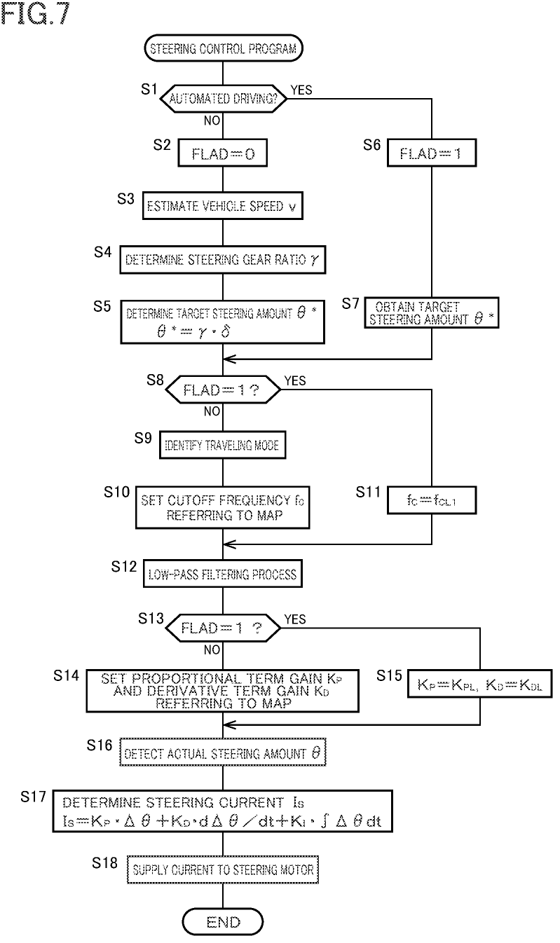

The computer of the steering ECU 20 repeatedly executes a steering control program represented by a flowchart of FIG. 7 at a short time pitch of from several to several tens of milliseconds, for instance, so that the steering control described above is executed. The flow of processing according to the steering control program will be briefly described referring to the flowchart.

In the processing according to the steering control program, the control flow starts with Step 1 to determine whether the vehicle 10 is performing automated driving based on whether the automated driving switch 96 is ON. (Hereinafter, Step 1 is abbreviated as “S1”. Other steps will be similarly abbreviated.) When the vehicle 10 is not performing automated driving, namely, when the vehicle 10 is performing manual driving, an automated driving flag FLAD is set to “0” at S2. The automated driving flag FLAD is set to “0” when the vehicle 10 is performing manual driving and set to “1” when the vehicle 10 is performing automated driving.

At S3, the vehicle speed v of the vehicle 10 is estimated based on the wheel speeds vw of the respective wheels 12 detected by the corresponding wheel speed sensors 94. At S4, the steering gear ratio γ is determined based on the estimated vehicle speed v referring to the map data illustrated in FIG. 4A. At S5, the target steering amount θ* is determined according to the expression described above utilizing the determined steering gear ratio γ.

When it is determined at S1 that the vehicle 10 is performing automated driving, the control flow proceeds to S6 to set the automated driving flag FLAD to “1”. At S7, the target steering amount θ* is obtained based on information transmitted from the automated driving ECU.

At S8, confirmation based on the flag value of the automated driving flag FLAD is conducted. When the vehicle 10 is performing automated driving, the control flow proceeds to S9 to identify whether the traveling mode being presently selected is the ECO mode or the sport mode based on the operated state of the traveling-mode selector switch 98. Based on the identified traveling mode at the present time point and the vehicle speed v, the cutoff frequency f_{C} in the filtering process is set referring to the map data of FIG. 4B. When the vehicle 10 is performing automated driving, the control flow proceeds to S11 to set the cutoff frequency f_{C} to the low frequency f_{CL1}. At S12, the low-pass filtering process is executed on the target steering amount θ* determined at S7. The procedure of the low-pass filtering process executed in the program is typical, a detailed description of which is dispended with.

At S13, confirmation based on the flag value of the automated driving flag FLAD is again conducted. When the vehicle 10 is performing manual driving, the control flow proceeds to S14 to set the proportional term gain K_{P} and the differential term gain K_{D} to be employed in determining the steering current I_{S} according to the PID the feedback control, based on the vehicle speed v while referring to the map data of FIG. 4C. When the vehicle 10 is performing automated driving, the control flow proceeds to S15 to set the proportional term gain K_{P} and the differential term gain K_{D} respectively to the low gain K_{PL} and the low gain K_{DL}.

At S16, the actual steering amount θ is detected by the steering amount sensor 80. At S17, the steering amount deviation Δθ is determined. The steering amount deviation Δθ is a deviation of the actual steering amount θ with respect to the target steering amount θ* on which the filtering process has been executed. Further, the steering current I_{S} to be supplied to the steering motor 24 is determined according to the technique of the PID feedback control law based on the steering amount deviation Δθ and the proportional term gain K_{P}, the differential term gain K_{D}, and the integral term gain K_{I} set as described above. At S18, the determined steering current I_{S} is supplied to the steering motor 24. Thus, one execution of the steering control program is ended.

### 2. Active Stabilizer System (Second Embodiment)

There will be hereinafter described an active stabilizer system (hereinafter simply referred to as “stabilizer system” where appropriate), which is a vehicle behavior control system according to a second embodiment. The present stabilizer system is mounted on the vehicle 10 on which the steering system described above is mounted.

### (A) Configuration of Active Stabilizer System

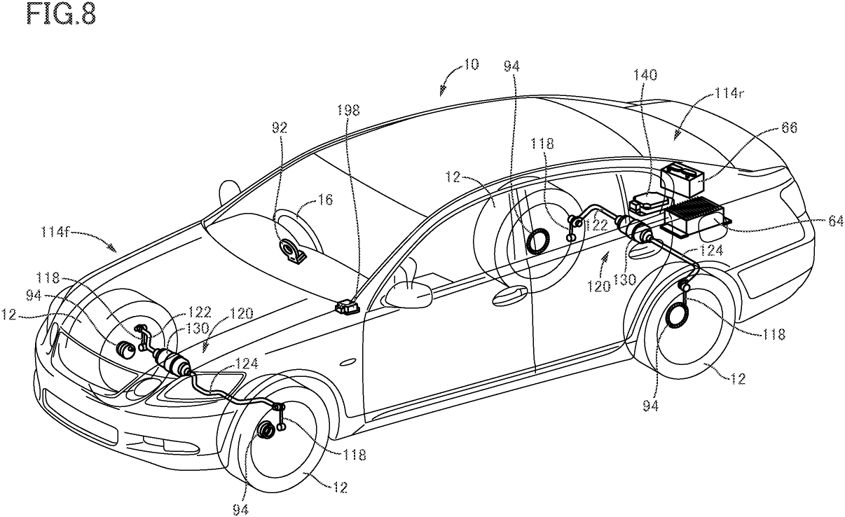

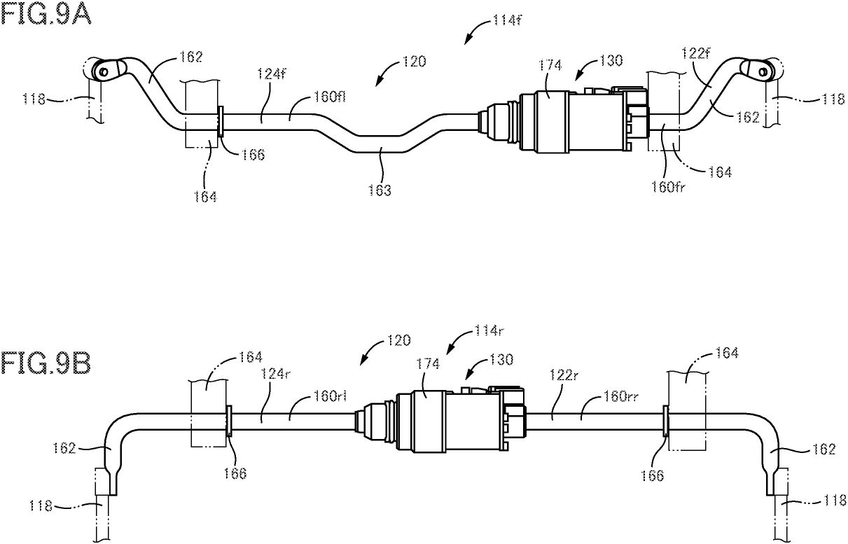

As illustrated in FIG. 8, the present stabilizer system includes two stabilizer devices 114 disposed on one and the other of a front-wheel side and a rear-wheel side of the vehicle 10. As illustrated in FIGS. 9, each stabilizer device 114 includes a stabilizer bar 120 coupled at opposite ends thereof, via respective link rods 118 each functioning as a coupling member, to respective suspension lower arms (not illustrated) each functioning as a wheel holding member that holds a corresponding one of the right and left wheels 12. The stabilizer bar 120 is constituted by a pair of stabilizer bar members, i.e., a right stabilizer bar member 122 and a left stabilizer bar member 124. The stabilizer bar members 122, 124 are coupled so as to be rotatable relative to each other via an actuator 130 interposed therebetween. The actuator 130 is an electric actuator. Roughly speaking, the stabilizer device 114 is configured such that the actuator 130 causes the right and left stabilizer bar members 122, 124 to rotate relative to each other to thereby change apparent stiffness of the stabilizer bar 120 as a whole (hereinafter referred to as “stabilizer stiffness” where appropriate), for suppressing the roll of the body of the vehicle 10. In the present stabilizer system, the front-wheel-side stabilizer device 114 and the rear-wheel-side stabilizer device 114 partly differ from each other in construction. In the following description, where it is necessary to distinguish the two stabilizer devices 114 between the front-wheel side and the rear-wheel side, a suffix “f” is attached to each of reference numerals assigned to the front-wheel-side stabilizer device 114 while a suffix “r” is attached to reference numerals assigned to the rear-wheel-side stabilizer device 114. In addition, where it is necessary to also distinguish the right side and the left side in each of the front-wheel-side stabilizer device 114 and the rear-wheel-side stabilizer device 114, each of the following suffixes “fr” (front-right-wheel side), “fl” (front-left-wheel side), “rr” (rear-right-wheel side), and “rl” (rear-left-wheel side) is attached to a corresponding one of reference numerals assigned to the front-wheel-side and the rear-wheel-side stabilizer devices 114.

As illustrated in FIG. 9A, the stabilizer bar members 122f, 124f of the front-wheel-side stabilizer device 114f respectively include: torsion bar portions 160fr, 160fl extending generally in a width direction of the vehicle 10; and arm portions 162, 162 formed integrally with the corresponding torsion bar portions 160fr, 160fl and intersecting the same 160fr, 160fl so as to extend generally in a rearward direction of the vehicle 10. The torsion bar portion 160fr of the right stabilizer bar member 122f is relatively short while the torsion bar portion 160fl of the left stabilizer bar member 124f is relatively long. The left stabilizer bar member 124f further includes a shifted or bent portion 163, which is shifted relative to the axis of the torsion bar portion 160fl. As illustrated in FIG. 9B, the stabilizer bar members 122r, 124r of the rear-wheel-side stabilizer device 114r respectively include: torsion bar portions 160rr, 160rl extending generally in the vehicle width direction by generally the same length; and arm portions 162, 162 formed integrally with the corresponding torsion bar portions 160rr, 160rl and intersecting the same 160rr, 160rl so as to extend generally in a frontward direction of the vehicle 10. Unlike the torsion bar portions 160fr, 160fl of the front-wheel-side stabilizer device 114f, the torsion bar portions 160rr, 160rl of the rear-wheel-side stabilizer device 114r have a linear shape. Further, the length of the torsion bar portion 160rr extending between the actuator 130 and the corresponding arm portion 162 and the length of the torsion bar portion 160rl extending between the actuator 130 and the corresponding arm portion 162 are substantially equal to each other.

Each of the torsion bar portions 160 of the respective stabilizer bar members 122f, 122r, 124f, 124r is rotatably supported, at a position close to the arm portion 162, by a support portion 164 fixedly provided on the vehicle body. The right and left torsion bar portions 160 of each of the right and left stabilizer bar members 122, 124 are disposed coaxially relative to each other. In each of the front-wheel-side stabilizer device 114f and the rear-wheel-side stabilizer device 114r, the actuator 130 is disposed to connect the right and left torsion bar portions 160. As described later in detail, one end of each torsion bar portion 160 opposite to the corresponding arm portion 162 is connected to the actuator 130. In the front-wheel-side stabilizer device 114f constructed as described above, the actuator 130 is disposed off-centered relative to the vehicle width direction, in other words, the actuator 130 is disposed at a position shifted rightward from the widthwise middle portion of the vehicle 10. In the rear-wheel-side stabilizer device 114r, the actuator 130 is disposed at substantially the widthwise middle portion of the vehicle 10. One end of each arm portion 162 opposite to the corresponding torsion bar portion 160 is connected to the corresponding wheel-holding member via the corresponding link rod 118. In the front-wheel-side stabilizer device 114f, the actuator 130 and a contacting member 166 fixedly provided on the torsion bar portion 160fl are respectively in contact with one and the other of mutually opposing surfaces of the two support portions 164 to thereby prevent the front-wheel-side stabilizer device 114f from moving in the vehicle width direction. In the rear-wheel-side stabilizer device 114r, two contacting members 166 fixedly provided on the respective torsion bar portions 160rr, 160rl are respectively in contact with one and the other of mutually opposing surfaces of the two support portions 164 to thereby_prevent the rear-wheel-side stabilizer device 114r from moving in the vehicle width direction.

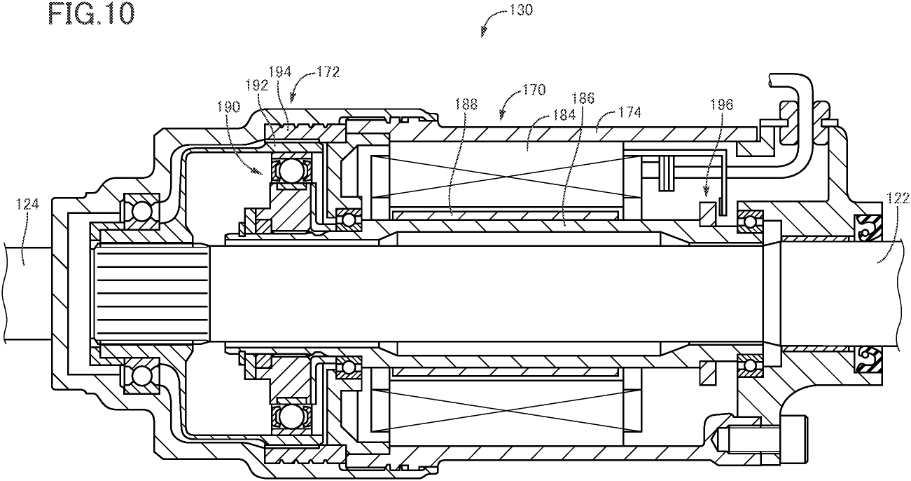

The actuator 130 of the front-wheel-side stabilizer device 114f and the actuator 130 of the rear-wheel-side stabilizer device 114r are identical in construction. As schematically illustrated in FIG. 10, the actuator 130 includes an electric motor 170, which functions as a drive source, and a speed reducer 172 for decelerating rotation of the electric motor 170. The electric motor 170 and the speed reducer 172 are housed in a housing 174. The housing 174 is an outer frame of the actuator 130. As apparent from FIG. 10, the left stabilizer bar member 124 is fixedly connected to one end of the housing 174 while the right stabilizer bar member 122 is disposed so as to extend into the housing 174 and is supported by the housing 174 so as to be rotatable and axially immovable relative to the same 174. One end of the right stabilizer bar member 122 located in the housing 174 is connected to the speed reducer 172.

The electric motor 170 includes: a plurality of stator coils 184 fixedly disposed on one circumference along the inner surface of the cylindrical wall of the housing 174; a hollow motor shaft 186 rotatably held by the housing 174; and permanent magnets 188 fixedly disposed on one circumference along the outer circumferential surface of the motor shaft 186 so as to face the stator coils 184. The stator coils 184 and the permanent magnets 188 of the electric motor 170 respectively function as a stator and a rotor. The electric motor 170 is a three-phase DC brushless motor.

The speed reducer 172 is constituted as a harmonic gear mechanism including a wave generator 190, a flexible gear 192, and a ring gear 194. The harmonic gear mechanism is called “HARMONIC DRIVE (trademark) or a strain wave gear ring mechanism. The wave generator 190 includes an oval cam and ball bearings fitted on the periphery of the cam. The wave generator 190 is fixed to one end of the motor shaft 186. The flexible gear 192 is shaped like a cup whose cylindrical wall portion is elastically deformable. A plurality of teeth is formed on an outer circumference of an open end portion of the cylindrical wall portion. The flexible gear 192 is connected to and supported by the right stabilizer bar member 122. Specifically, the right stabilizer bar member 122 extends through the motor shaft 186 and has one end portion extending out of the motor shaft 186. To this end portion of the right stabilizer bar member 122, a bottom portion of the flexible gear 192, which functions as an output portion of the speed reducer 172, is connected by serration engagement in a state in which the end portion of the right stabilizer bar member 122 extends through the bottom portion of the flexible gear 192 such that the right stabilizer bar member 122 and the flexible gear 192 are unrotatable and axially immovable relative to each other. The ring gear 194 is generally shaped like a ring and is fixed to the housing 174. A plurality of teeth is formed on an inner circumference of the ring gear 194. The number of teeth formed on the inner circumference of the ring gear 194 is slightly greater (e.g., greater by two) than the number of teeth formed on the outer circumference of the flexible gear 192. The flexible gear 192 is fitted at the cylindrical wall portion thereof on the wave generator 190 and is elastically deformed into an oval shape. The flexible gear 192 meshes the ring gear 194 at two portions thereof corresponding to opposite ends of the long axis of the oval and does not mesh the same 194 at the other portion. With one rotation of the wave generator 190 (i.e., after rotation of the wave generator 190 by 360 degrees), in other words, after one rotation of the motor shaft 186 of the electric motor 170, the flexible gear 192 and the ring gear 194 are rotated relative to each other by an amount corresponding to a difference in the number of teeth therebetween.

In the thus constructed stabilizer device 114, when the vehicle body undergoes, due to turning or the like of the vehicle 10, a force that changes a distance between one of the right and left wheels 12 and the vehicle body and a distance between the other of the right and left wheels 12 and the vehicle body, relative to each other, namely, when a roll moment acts on the vehicle body, the actuator 130 receives a force that rotates the right and left stabilizer bar members 122, 124 relative to each other, namely, the actuator 130 receives an external input force that acts thereon. In this instance, when the actuator 130 generates, as an actuator force, a force that is in balance with the external input force owing to a motor force generated by the electric motor 170, one stabilizer bar 120 constituted by the two stabilizer bar members 122, 124 is twisted. (The motor force indicated above will be hereinafter referred to as “rotational torque” where appropriate because the electric motor 170 is a rotation motor and therefore the force generated by the electric motor 170 is considered as a rotational torque.) The elastic force generated by the twisting of the stabilizer bar 120 functions as a force that counters the roll moment, i.e., a roll suppressing force. By changing, owing to the motor force, the rotational position (operational position) of the actuator 130, the relative rotational position of the right and left stabilizer bar members 122, 124 is changed, so that the roll suppressing force is changed to change the roll amount of the vehicle body. Thus, the present stabilizer device 114 is capable of changing the stabilizer stiffness.

The actuator 130 has, in the housing 174 thereof, a motor rotational angle sensor 196 for detecting a rotational angle of the motor shaft 186, namely, a motor rotational angle Ψ, which is a rotational angle of the electric motor 170. The motor rotational angle sensor 196 of the present actuator 130 is constituted principally by an encoder. The motor rotational angle Ψ is utilized in the control of the actuator 130, namely, in the control of the stabilizer device 114, as an index indicative of a relative rotational angle (relative rotational position) of the right and left stabilizer bar members 122, 124), in other words, as an index indicative of a motion amount, namely, a rotational amount, of the actuator 130.

As illustrated in FIG. 8, electric power is supplied from the battery 66 to the electric motor 170 of the actuator 130. The present stabilizer system is provided with a converter 64 for raising the voltage supplied from the battery 66. The converter 64 and the battery 66 constitute a power source. A stabilizer electronic control unit 140 (hereinafter simply referred to as “stabilizer ECU 140” where appropriate) is disposed between the converter 64 and the two stabilizer devices 114. Though not illustrated, the stabilizer ECU 140 includes two inverters respectively functioning as drive circuits for the respective electric motors 170 and a computer including a CPU, a ROM, a RAM, etc. The stabilizer ECU 140 functions as a controller configured to control the actuators 130. The electric power is supplied to each of the two electric motors 170 of the respective two stabilizer devices 114 via a corresponding one of the two inverters of the stabilizer ECU 140. Each electric motor 170 is driven at a constant voltage. Accordingly, the amount of the electric power to be supplied is changed by changing an amount of the current to be supplied, and the electric motor 170 generates a force corresponding to the amount of the current supplied thereto. In this respect, the amount of the current to be supplied is changed such that a ratio between a pulse-on time and a pulse-off time (duty ratio) in PWM (Pulse Width Modulation) is changed by the inverter.

As illustrated in FIG. 8, there are connected, to the stabilizer ECU 140, the operation amount sensor 92 for detecting the operation amount (operation angle) δ of the steering wheel 16, which is the steering operating member, and a lateral acceleration sensor 198 for detecting actual lateral acceleration Gy_{R}, which is lateral acceleration Gy actually generated in the vehicle body, in addition to the motor rotational angle sensor 196 described above. There are further connected, to the stabilizer ECU 140, the wheel speed sensors 94 provided for the respective four wheels 12 to detect the respective wheel speeds vw. The computer of the stabilizer ECU 140 is configured to detect the vehicle speed v based on the detection values of the respective wheel speed sensors 94.

### (B) Control of Active Stabilizer System

As described above, the present stabilizer system includes the two stabilizer devices 114, i.e., the front-wheel-side stabilizer device 114f and the rear-wheel-side stabilizer device 114r. The two stabilizer devices 114 are individually controlled by the stabilizer ECU 140, which functions as the controller, based on predetermined roll stiffness distribution. The two stabilizer devices 114 are substantially identical in configuration. Thus, substantially the same control is executed for the two stabilizer devices 114. In view of this, the following description will be made focusing on one stabilizer device 114, regardless of on which one of the front-wheel side and the rear-wheel side the stabilizer device 114 is disposed.

### I) Basic Control

The stabilizer ECU 140 determines a target rotational position of the actuator 130 based on a roll-moment index amount indicative of the roll moment that the vehicle body receives, and the rotational position of the actuator 130 is controlled so as to coincide with the target rotational position. The term “the rotational position of the actuator 130” used herein means the motion amount of the actuator 130. Specifically, a state in which no roll moment acts on the vehicle body is defined as a reference state, and the rotational position of the actuator 130 in the reference state is defined as a neutral position. In this case, the rotational position of the actuator 130 means the rotational amount from the neutral position. In other words, the rotational position of the actuator 130 means a displacement amount of the operational position of the actuator 130 with respect to the neutral position. Further, there is a correspondence relationship between the rotational position of the actuator 130 and the motor rotational angle of the electric motor 170. In the actual control, therefore, the motor rotational angle Ψ is utilized in place of the rotational position of the actuator 130. Moreover, the actuator 130 is an electric actuator for changing the posture of the vehicle 10, namely, for changing the roll posture of the vehicle body, and the stabilizer ECU 140, which functions as the controller, controls the motion amount of the actuator 130 as the control subject. In other words, the stabilizer ECU 140 controls the motor rotational angle Ψ of the electric motor 170 as the control subject.

The control of the stabilizer device 114 will be described more specifically. The lateral acceleration Gy, which is the roll-moment index amount, is a factor that causes the posture of the vehicle 10 to be changed. Based on the lateral acceleration Gy, the stabilizer ECU 140 determines a target motor rotational angle Ψ*, which is a target value of the motor rotational angle Ψ, for obtaining appropriate stabilizer stiffness. Specifically, the stabilizer ECU 140 estimates lateral acceleration Gy based on the operation amount δ of the steering wheel 16 detected by the operation amount sensor 92 and the vehicle speed v estimated based on the wheel speeds vw of the respective wheels 12 detected by the corresponding wheel speed sensors 94. (The thus estimated lateral acceleration Gy will be hereinafter referred to as “estimated lateral acceleration Gy_{E}” where appropriate.) The stabilizer ECU 140 determines, according to the following expression, control lateral acceleration Gy*, which is the lateral acceleration Gy to be utilized in the control, based on the estimated lateral acceleration Gy_{E} and the actual lateral acceleration Gy_{R} detected by the lateral acceleration sensor 198:

$$\begin{matrix}{\text{Gy}}^{*} = {\text{K}}_{\text{E}} ⋅ {\text{Gy}}_{\text{E}} {\text{+K}}_{\text{R}} ⋅ {\text{Gy}}_{\text{R}} & \left({\text{K}}_{\text{E}} , {\text{K}}_{\text{R}} \text{: weighting coefficients}\right)\end{matrix}$$

The stabilizer ECU 140 determines the target motor rotational angle Ψ* based on the control lateral acceleration Gy* determined as described above. Specifically, the stabilizer ECU 140 determines the target motor rotational angle Ψ* such that appropriate stabilizer stiffness corresponding to the control lateral acceleration Gy* is obtained. In the meantime, the stabilizer ECU 140 detects, via the rotational angle sensor 196, an actual motor rotational angle Ψ, which is an actual value of the motor rotational angle Ψ. Based on a motor rotational angle deviation ΔΨ, which is a deviation of the actual motor rotational angle Ψ with respect to the target motor rotational angle Ψ*, the stabilizer ECU 140 determines a supply current I_{S} to be supplied to the electric motor 170 according to a PID feedback control technique. Specifically, the stabilizer ECU 140 determines the supply current I_{S} according to the following expression similar to the expression described above with respect to the steering system:

$${\text{I}}_{\text{S}} \text{=} {\text{K}}_{\text{P}} ⋅ Δ \text{ψ+} {\text{K}}_{\text{D}} ⋅ \text{d} Δ \text{ψ} / {\text{dt+K}}_{\text{I}} ⋅ \int Δ \text{ψ} \text{dt}$$

Based on the supply current I_{S} determined as described above, the stabilizer ECU 140 supplies a current to the electric motor 170 via the inverter.

### II) Current Reduction Process

A current reduction process is executed also in the present stabilizer system. Specifically, the current reduction process is executed on the supply current to the actuator 130 in a specific situation in consideration of power and energy saving. The current reduction process executed in the present stabilizer system will be hereinafter described.

Like the steering ECU 20 of the steering system described above, the stabilizer ECU 140 of the present stabilizer system identifies that the vehicle 10 is in the specific situation and executes the current reduction process when the vehicle speed v of the vehicle 10 is not higher than the threshold vehicle speed v_{TH}, e.g., 20-30 km/h, and when the vehicle 10 is performing automated driving, in consideration of the response of the actuator 130, etc.

In the steering system according to the first embodiment illustrated above, the low-pass filtering process is executed on the target motion amount of the actuator as the current reduction process. In the present stabilizer system, such low-pass filtering process is not executed, but only the gain reduction process is executed for reducing the proportional term gain K_{P} and the differential term gain K_{D} utilized in determining the supply current I_{S} according to the feedback control technique. In the present stabilizer system, however, only a high gain K_{PH} and a low gain K_{PL} are set for the proportional term gain K_{P}, and only a high gain K_{DH} and a low gain K_{DL} are set for the differential term gain K_{D}. The stabilizer ECU 140 simply sets the proportional term gain K_{P} and the differential term gain K_{D} respectively to the high gain K_{PH} and the high gain K_{DH} when the vehicle 10 is not in the specific situation and simply sets the proportional term gain K_{P} and the differential term gain K_{D} respectively to the low gain K_{PL} and the low gain K_{DL} when the vehicle 10 is in the specific situation. In the gain reduction process of the present stabilizer system, the proportional term gain K_{P} and the differential term gain K_{D} are not gradually changed depending on the vehicle speed v between the high gain K_{PH} and the low gain K_{PL} and between the high gain K_{DH} and the low gain K_{DL}, in contrast to the gain reduction process in the steering system described above. The current reduction process thus executed in the present stabilizer system also adequately achieves power and energy saving.

In the present stabilizer system, the rotational angle of the electric motor 170 of the actuator 130 is the control target. Though not described in detail, a low-pass filtering process similar to the low-pass filtering process executed in the steering system described above may be executed as the current reduction process on the target motor rotational angle Ψ*, which is the target value of the control subject. As in the gain reduction process of the steering system described above, the proportional term gain K_{P} and the differential term gain K_{D} may be gradually changed depending on the vehicle speed v respectively between the high gain K_{PH} and the low gain K_{PL} and between the high gain K_{DH} and the low gain K_{DL} in the gain reduction process of the present stabilizer system.

In the steering system according to the first embodiment illustrated above, the functions of the steering ECU 20, which is the controller, are explained referring to the block diagram. The functions of the stabilizer ECU 140 of the present stabilizer system, which is the controller, are similar to those of the steering ECU 20, and a description of the functions of the stabilizer ECU 140 referring to a block diagram is dispensed with.

### III) Control Flow

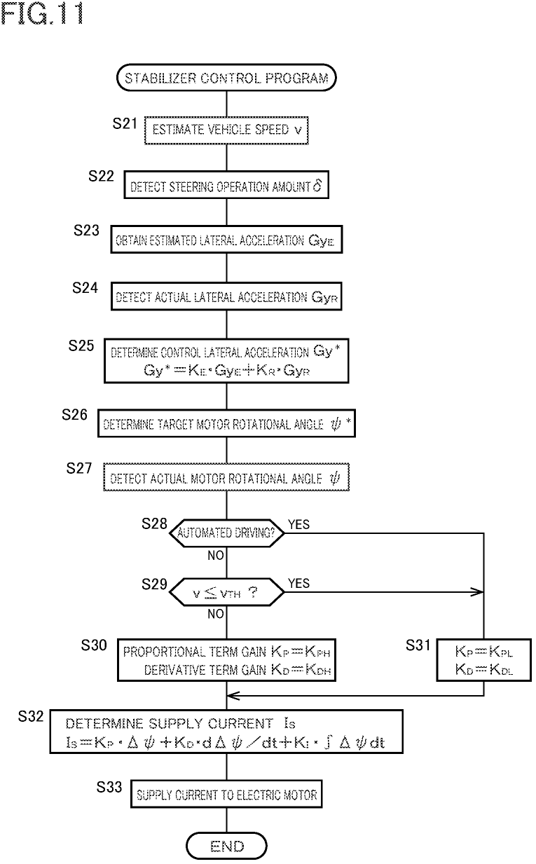

The computer of the stabilizer ECU 140 repeatedly executes a stabilizer control program represented by a flowchart of FIG. 11 at a short time pitch of from several to several tens of milliseconds, for instance, so that the control of the stabilizer device 114 described above is executed. The flow of processing according to the stabilizer control program will be briefly described referring to the flowchart.

In the processing according to the stabilizer control program, the control flow starts with S21 to estimate the vehicle speed v of the vehicle 10 based on the wheel speeds vw of the respective wheels 12 detected by the corresponding wheel speed sensors 94. At S22, the operation amount δ of the steering wheel 16 is detected via the operation amount sensor 92. At S23, the estimated lateral acceleration Gy_{E} is obtained based on the vehicle speed v and the operation amount δ. At S24, the actual lateral acceleration Gy_{R} is detected by the lateral acceleration sensor 198. At S25, the control lateral acceleration Gy* is determined as described above based on the estimated lateral acceleration Gy_{E} and the actual lateral acceleration Gy_{R}.

At S26, the target motor rotational angle Ψ* is determined based on the control lateral acceleration Gy* determined as described above. At S27, the actual motor rotational angle Ψ is detected by the rotational angle sensor 196.

It is determined at S28 whether the vehicle 10 is performing automated driving. When the vehicle 10 is performing manual driving, the control flow proceeds to S29 to determine whether the vehicle speed v is not higher than the threshold vehicle speed v_{TH}. When it is determined that the vehicle speed v is higher than the threshold vehicle speed v_{TH}, the control flow proceeds to S30 at which the proportional term gain K_{P} and the differential term gain K_{D} are set respectively to the high gain K_{PH} and the high gain K_{DH}. When it is determined that the vehicle 10 is performing automated driving and when it is determined at S29 that the vehicle speed v is not higher than the threshold vehicle speed v_{TH}, the control flow proceeds to S31 at which the proportional term gain K_{P} and the differential term gain K_{D} are set respectively to the low gain K_{PL} and the low gain K_{DL}.

At S32, the motor rotational angle deviation ΔΨ, which is the deviation of the actual motor rotational angle Ψ with respect to the target motor rotational angle Ψ* is determined, and the supply current I_{S} to the electric motor 170 of the actuator 130 is determined based on the motor rotational angle deviation ΔΨ, the proportional term gain K_{P}, the differential term gain K_{D}, and the integral term gain K_{I}, according to the PID feedback control law. At S33, the determined supply current I_{S} is supplied to the electric motor 170 via the inverter. Thus, one execution of the stabilizer control program is ended.

### 3. Active Suspension System (Third Embodiment)

There will be hereinafter described an active suspension system (hereinafter simply referred to as “suspension system” where appropriate), which is a vehicle behavior control system according to a third embodiment. The present suspension system is mounted on the vehicle 10 on which the steering system and the stabilizer system described above are mounted.

### (A) Configuration of Active Suspension System

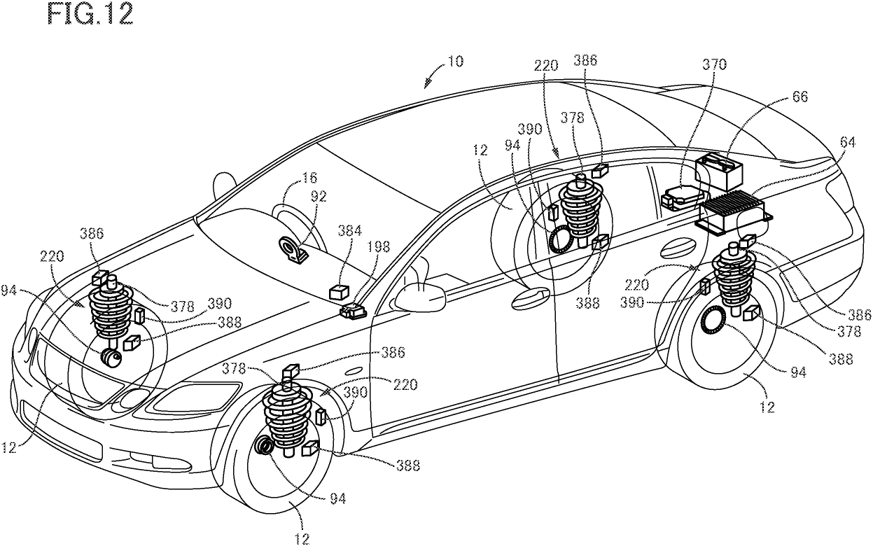

As illustrated in FIG. 12, the suspension system according to the third embodiment includes four suspension devices 220 respectively provided for four wheels 12, i.e., front right and left wheels 12 and rear right and left wheels 12, and a control system configured to control the four suspension devices 220. The suspension devices 220 for the front wheels that are steerable wheels and the suspension devices 220 for the rear wheels that are non-steerable wheels can be considered to be identical in configuration, except for a mechanism that enables the wheels 12 to be steered. Thus, there will be described a configuration of each suspension device 220 focusing on one of the suspension devices 220 provided for the rear wheels.

### I) Configuration of Suspension Device

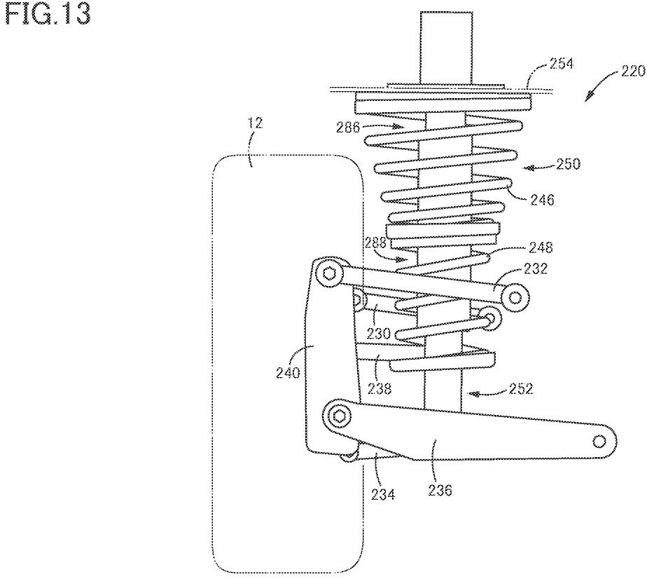

As illustrated in FIG. 13, the suspension device 220 is of an independent type and a multi-link type. The suspension device 220 includes a first upper arm 230, a second upper arm 232, a first lower arm 234, a second lower arm 236, and a toe control arm 238, each of which is a suspension arm. One end of each of the five arms 230, 232, 234, 236, 238 is pivotably coupled to the vehicle body, and the other end of each of the five arms 230, 232, 234, 236, 238 is pivotably coupled to an axle carrier 240 that rotatably holds the wheel 12. The five arms 230, 232, 234, 236, 238 enable the axle carrier 240 to be moved upward and downward relative to the vehicle body along a constant locus.

The suspension device 220 includes: two compression coil springs 246, 248 disposed in series; an electromagnetic actuator 250 (hereinafter simply referred to as “actuator 250” where appropriate), which is an electric actuator; and a hydraulic damper 252. The two coil springs 246, 248 cooperate with each other to function as a suspension spring for elastically connecting a sprung portion and an unsprung portion to each other. The actuator 250 functions as a shock absorber. The actuator 250 is disposed between a mount portion 254 provided in a tire housing and the second lower arm 236. The mount portion 254 is one constituent element of the sprung portion while the second lower arm 236 is one constituent element of the unsprung portion.

### II) Configuration of Electromagnetic Actuator

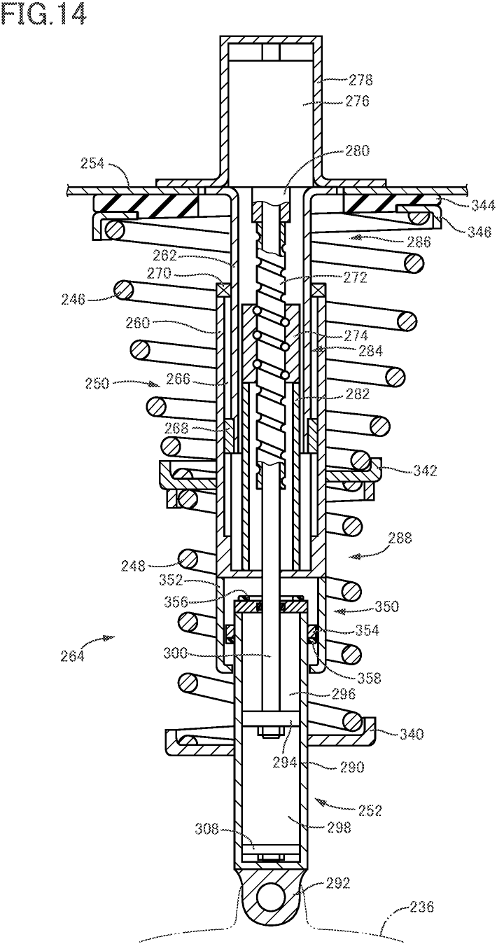

As illustrated in FIG. 14, the actuator 250 of the suspension device 220 includes an outer tube 260 and an inner tube 262 disposed in the outer tube 260 so as to extend upward from an upper end portion of the outer tube 260. As later described in detail, the outer tube 260 is coupled to the second lower arm 236 via a coupling mechanism 264, which includes the compression coil spring 248 as a constituent element. The inner tube 262 is coupled at an upper end portion thereof to the mount portion 254.

The outer tube 260 has a pair of guide grooves 266 formed on its inner wall surface so as to extend in the axial direction of the actuator 250 while the inner tube 262 has a pair of keys 268 attached to its lower end portion. The pair of keys 268 is held in engagement with the pair of guide grooves 266, whereby the outer tube 260 and the inner tube 262 are movable relative to each other in the axial direction while being unrotatable relative to each other. A dust seal 270 is attached to the upper end portion of the outer tube 260 for preventing entry of dusts, mud, etc., from outside.

The actuator 250 includes a hollow, externally threaded rod 272, a nut 274 holding bearing balls and threadedly engaging the threaded rod 272, and an electric motor 276.

The electric motor 276 is fixedly housed in a motor housing 278. The motor housing 278 is fixed at its flange portion to the upper surface of the mount portion 254, so that the motor housing 278 is fixed to the mount portion 254. The upper end portion of the inner tube 262 shaped like a flange is fixed to the flange portion of the motor housing 278. Thus, the inner tube 262 is fixedly coupled to the mount portion 254.

A motor shaft 280, which is a rotational shaft of the electric motor 276, is a hollow shaft. The motor shaft 280 is coupled integrally to an upper end portion of the threaded rod 272. That is, the threaded rod 272 is disposed in the inner tube 262 so as to continuously extend from the motor shaft 280. To the threaded rod 272, the rotational force is applied from the electric motor 276. A cylindrical support member 282 is fixed to an inner bottom portion of the outer tube 260 such that the threaded rod 272 is disposed in the cylindrical support member 282. The nut 274 is fixed to an upper end portion of the cylindrical support member 282. The threaded rod 272 is threadedly engaged with the nut 274 fixed to the cylindrical support member 282. The threaded rod 272 and the nut 274 constitute a screw mechanism 284.

The actuator 250 constructed as described above includes a sprung-side unit 286 including the inner tube 262, the motor housing 278, the electric motor 276, the threaded rod 272, etc., and an unsprung-side unit 288 including the outer tube 260, the cylindrical support member 282, the nut 274, etc. In the thus constructed actuator 250, a relative movement of the sprung portion and the unsprung portion causes the sprung-side unit 286 and the unsprung-side unit 288 to be moved relative to each other and causes the threaded rod 272 and the electric motor 276 to be rotated. Further, the electric motor 276 applies the rotational force to the threaded rod 272, so that the actuator 250 generates an actuator force that is a force with respect to the relative movement of the sprung-side unit 286 and the unsprung-side unit 288. The actuator force acts on the sprung portion and the unsprung portion via the compression coil spring 248.

### III) Configuration of Damper

The damper 252 of the suspension device 220 is constituted as a cylinder device. The damper 252 is disposed between the actuator 250 and the second lower arm 236. The damper 252 includes a generally cylindrical housing 290 coupled to the second lower arm 236 at a joint portion 292 fixedly provided at a lower end portion of the housing 290. The housing 290 stores a working fluid in an inner space thereof. A piston 294 is disposed in the housing 290 so as to partition the inner space of the housing 290 into two fluid chambers, i.e., an upper fluid chamber 296 and a lower fluid chamber 298. The piston 294 is slidable relative to the housing 290.

The damper 252 includes a piston rod 300 coupled at a lower end thereof to the piston 294 and extending through a cap portion of the housing 290. The piston rod 300 extends through an opening formed at the bottom of the outer tube 260 and also extends through the threaded rod 272 and the motor shaft 280 such that the piston rod 300 is fixed at the upper end thereof to the motor housing 278.

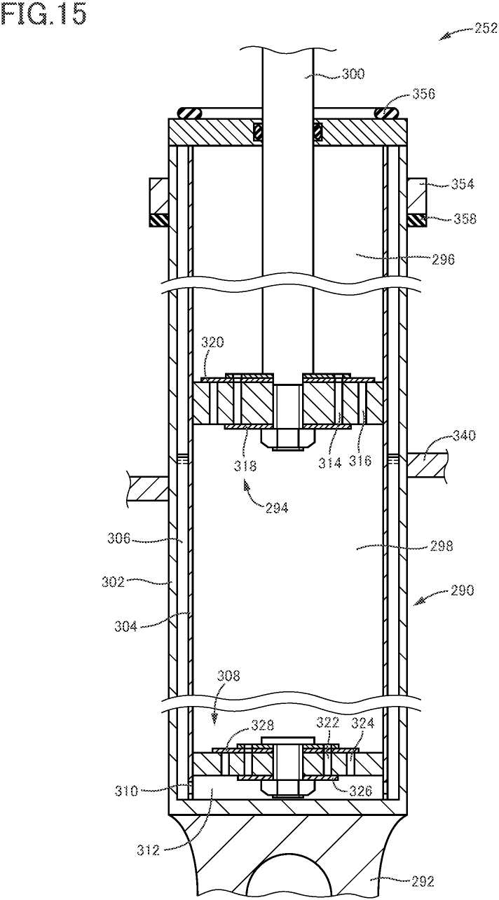

The damper 252 has a structure similar to that of a shock absorber of a twin tube type. As illustrated in FIG. 15, the housing 290 of the damper 252 has a twin tube structure constituted by an outer cylindrical member 302 and an inner cylindrical member 304 between which is formed a buffer chamber 306. A partition wall 308 is provided in the vicinity of an inner bottom portion of the housing 290 to define an auxiliary fluid chamber 312 communicating with the buffer chamber 306 via a communication hole 310. That is, the lower fluid chamber 298 and the buffer chamber 306 are held in communication with each other via the auxiliary fluid chamber 312.

The piston 294 has a plurality of communication passages 314, 316 (two of which are illustrated in FIG. 15) formed through the thickness of the piston 294 so as to extend in the axial direction. The upper fluid chamber 296 and the lower fluid chamber 298 are brought into communication with each other through the communication passages 314, 316. Disc-like valve members 318, 320 formed of an elastic material are provided respectively on the lower surface and the upper surface of the piston 294. The valve member 318 closes openings of the communication passages 314 located nearer to the lower fluid chamber 298, and the valve member 320 closes openings of the communication passages 316 located nearer to the upper fluid chamber 296.

Like the piston 294, the partition wall 308 has a plurality of communication passages 322, 324 (two of which are illustrated in FIG. 15) formed through the thickness of the partition wall 308. The lower fluid chamber 298 and the auxiliary fluid chamber 312 are brought into communication with each other through the communication passages 322, 324. Disc-like valve members 326, 328 formed of an elastic material are provided respectively on the lower surface and the upper surface of the partition wall 308. The valve member 326 closes openings of the communication passages 322 located nearer to the auxiliary fluid chamber 312, and the valve member 328 closes openings of the communication passages 324 located nearer to the lower fluid chamber 298.

When the piston 294 is moved upward in the housing 290, the working fluid in the upper fluid chamber 296 partly flows into the lower fluid chamber 298 through the communication passages 314, and the working fluid in the buffer chamber 306 partly flows into the lower fluid chamber 298 through the communication passages 324. In this instance, the working fluid flows into the lower fluid chamber 298 while deflecting the valve member 318 and the valve member 328, so that a resistance is applied to the upward movement of the piston 294. When the piston 294 is moved downward in the housing 290, the working fluid in the lower fluid chamber 298 partly flows into the upper fluid chamber 296 through the communication passages 316 while flowing into the buffer chamber 306 through the communication passages 322. In this instance, the working fluid flows out of the lower fluid chamber 298 while deflecting the valve member 320 and the valve member 326, so that a resistance is applied to the downward movement of the piston 294.

The thus constructed damper 252 allows fluid communication between the upper fluid chamber 296 and the lower fluid chamber 298 and between the lower fluid chamber 298 and the buffer chamber 306 owing to the upward and downward movement of the piston 294 relative to the housing 290. The thus constructed damper 252 includes a flow-resistance application mechanism for applying a resistance to the fluid communication. That is, the damper 252 is configured to generate a resistance force against the relative movement of the sprung portion and the unsprung portion, namely, a damping force against the relative movement.

### IV) Configurations of Suspension Spring and Coupling Mechanism

A lower spring seat 340 shaped like a flange is attached to the outer circumferential surface of the housing 290. An intermediate spring seat 342 shaped like a flange is attached to the outer circumferential surface of the outer tube 260. The compression coil spring 248 is disposed in a compressed state so as to be sandwiched between the lower spring seat 340 and the intermediate spring seat 342. An upper spring seat 346 is attached to the lower surface of the mount portion 254 via a vibration damping rubber 344. The compression coil spring 246 is disposed in a compressed state so as to be sandwiched between the intermediate spring seat 342 and the upper spring seat 346.

The compression coil spring 246 functions as a coupler spring elastically coupling the sprung portion and the unsprung-side unit 288, and the compression coil spring 248 functions as a support spring by which the unsprung-side unit 288 is elastically supported by the unsprung portion. Thus, the compression coil spring 246 and the compression coil spring 248 cooperate with each other to function as the suspension spring for elastically coupling the sprung portion and the unsprung portion. Further, the compression coil spring 248 is a constituent element of the coupling mechanism 264 for elastically coupling the unsprung portion and the unsprung-side unit 288.

In the present suspension device 220, the sprung-side unit 286 of the actuator 250 is fixedly coupled as a fixed unit to the sprung portion that is a unit fixation portion while the unsprung-side unit 288 of the actuator 250 is floatingly supported as a floating unit by the unsprung portion that is a unit-floatingly support portion. In the present suspension device 220, the unsprung-side unit 288 is also floatingly supported by the sprung portion via the compression coil spring 246.

The coupling mechanism 264 allows a movement of the unsprung-side unit 288 relative to the unsprung portion. A relative displacement of the unsprung-side unit 288 and the unsprung portion in the relative movement thereof is limited by a relative-displacement limiting mechanism 350 of the coupling mechanism 264. The relative-displacement limiting mechanism 350 is constituted by the bottom portion of the outer tube 260, the upper end portion of the housing 290 of the damper 252, a cylindrical skirt 352 attached to the bottom portion of the outer tube 260, a stopper ring 354 attached to the outer circumferential portion of the housing 290, etc.

Specifically, when the unsprung-side unit 288 moves toward the unsprung portion, the bottom portion of the outer tube 260 comes into contact with the upper end portion of the housing 290 of the damper 252 via a cushion rubber 356, so that the movement of the unsprung-side unit 288 toward the unsprung portion is limited. When the unsprung-side unit 288 moves away from the unsprung portion, the lower end portion of the skirt 352 shaped like an inward flange comes into contact with the stopper ring 354 via a cushion rubber 358, so that the movement of the unsprung-side unit 288 away from the unsprung portion is limited.

### V) Configuration of Control System

As illustrated in FIG. 12, the suspension system according to the present embodiment includes a suspension electronic control unit 370 (hereinafter abbreviated as “suspension ECU 370” where appropriate), which is a controller configured to control, as a control subject, the motion of each of the four actuators 250, namely, the actuator force of each actuator 250. The suspension ECU 370 is constituted mainly by a computer including a CPU, a ROM, a RAM, etc. The suspension ECU 370 includes four inverters each of which is a drive circuit of the electric motor 276 of a corresponding one of the actuators 250. Each inverter is connected to the battery 66, which is the power source, via the converter 64, and is connected to the electric motor 276 of the corresponding actuator 250. Each electric motor 276 is a DC brushless motor and is driven at a constant voltage. The control of the actuator force of each actuator 250 is executed by controlling a current that flows through the corresponding electric motor 276. The current that flows through the electric motor 276 is controlled by changing a ratio between a pulse-on time and a pulse-off time (duty ratio) in PWM (Pulse Width Modulation). The rotational angle φ of each electric motor 276 is detected by a corresponding motor rotational angle sensor 378. The inverter controls the operation of the corresponding electric motor 76 based on the detected motor rotational angle φ.

In addition to the four motor rotational angle sensors 378, the following sensors are connected to the suspension ECU 370: the operation amount sensor 92 for detecting the operation amount (operation angle) δ of the steering wheel 16, which is the steering operating member; the lateral acceleration sensor 198 for detecting the actual lateral acceleration Gy_{R}, which is the lateral acceleration Gy being actually generated in the vehicle body; and a longitudinal acceleration sensor 384 for detecting longitudinal acceleration Gx being generated in the vehicle body. There are further connected, to the suspension ECU 370, various sensors provided so as to correspond to the four suspension devices 220, such as sprung vertical acceleration sensors 386 each for detecting the sprung acceleration Gu, which is vertical acceleration of the sprung portion; unsprung vertical acceleration sensors 388 each for detecting unsprung acceleration G_{L}, which is vertical acceleration of the unsprung portion; stroke sensors 390 each for detecting a stroke amount S that corresponds to a distance between the sprung portion and the unsprung portion. Further, the four wheel speed sensors 94 provided for the respective four wheels 12 to detect the rotational speeds of the corresponding wheels 12 are connected to the suspension ECU 370. The suspension ECU 370 is configured to detect the vehicle speed v, which is the traveling speed of the vehicle 10, based on the detection values of the four wheel speed sensors 94.

In the control system of the present suspension system, the suspension ECU 370 controls the current to be supplied to the electric motor 276 of each actuator 250 based on signals transmitted from the sensors described above to thereby control the motion of each actuator 250, namely, the actuator force of each actuator 250.

### (B) Control of Electromagnetic Actuator

The suspension ECU 370 of the present suspension system controls the actuators 250 of the respective four suspension devices 220 to thereby execute the following two controls. Specifically, the suspension ECU 370 executes a sprung-vibration damping control for damping a vibration of the sprung portion and a body-posture-change suppressing control for suppressing pitch and roll of the vehicle body. In view of the significance of the body-posture-change suppressing control, the actuator 250 may be considered as an electric actuator for changing the posture of the vehicle. The four actuators 250 are substantially identical in configuration and function. Thus, it can be considered that the controls of the four actuators 250 are mutually the same. Accordingly, the following description will be made focusing on the control of the actuator 250 of one suspension device 220.

### I) Sprung-Vibration Damping Control

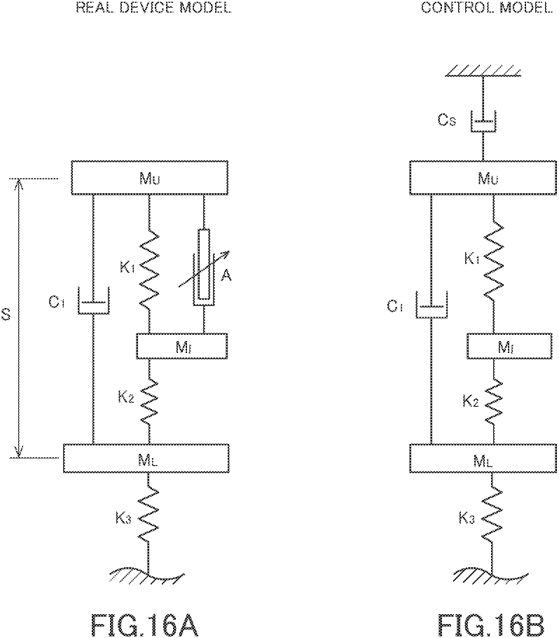

FIG. 16A illustrates a vibration model based on a real device construction of the suspension device 220 (hereinafter referred to as “real device model” where appropriate). The vibration model includes a sprung mass M_{U}, which is an inertial mass of the sprung portion, an unsprung mass M_{L}, which is an inertial mass of the unsprung portion, and an intermediate mass M_{I}, which is an inertial mass with regard to the movement of the unsprung-side unit 288 of the actuator 250 that will be later explained. In this model, there is disposed, between the sprung mass M_{U} and the unsprung mass M_{L}, a damper corresponding to the damper 252, i.e., a damper C₁ whose damping coefficient is C_{1.} Further, there are disposed, between the sprung mass M_{U} and the intermediate mass M_{I}, a spring corresponding to the compression coil spring 246, i.e., a spring K₁ whose spring constant is K₁, and an actuator A corresponding to the actuator 250, such that spring K₁ and the actuator A are disposed in parallel to each other. Moreover, there is disposed, between the intermediate mass M_{I} and the unsprung mass M_{L}, a spring corresponding to the compression coil spring 248, i.e., a spring K₂ whose spring constant is K₂. Further, there is disposed, between the unsprung mass M_{L} and the road surface, a spring corresponding to the tire, i.e., a spring K₃ whose spring constant is K₃.

FIG. 16B illustrates a control model that is a theoretical model for controlling the actuator 250. In this control model, the sprung mass M_{U} is suspended by a skyhook damper Cs whose damping coefficient is Cs. That is, the control model is based on a skyhook damper theory.

In the sprung-vibration damping control, the actuator 250 is controlled according to the control model including the skyhook damper Cs, such that the actuator force generated by the actuator A in the real device model becomes equal to the damping force generated by the skyhook damper Cs in the control model. More specifically, a sprung speed vu, which is a moving speed (absolute speed) of the sprung portion, is calculated based on vertical acceleration G_{U} of the sprung portion (hereinafter referred to as “sprung acceleration G_{U}” where appropriate) detected by the sprung vertical acceleration sensor 386, and the operation of the electric motor 276 is controlled such that the actuator 250 generates, as a sprung-vibration damping component F_{U}, the actuator force based on the following expression, namely, the actuator force having a magnitude corresponding to the sprung speed vu.

$${\text{F}}_{\text{U}} {\text{=C}}_{\text{S}} ⋅ {\text{v}}_{\text{U}}$$

The damping coefficient Cs can be considered as a control gain. The damping coefficient Cs is set to a value suitable for effectively damping vibrations at and around the sprung resonance frequency. In the present suspension system, the damper 252 deals with a resonance phenomenon of the unsprung portion. That is, the damping coefficient C₁ of the damper C₁ in the real device model and the control model described above, namely, the damping coefficient of the damper 252, is set to a value for effectively damping vibrations at and around the unsprung resonance frequency.

### II) Body-Posture-Change Suppressing Control

In the present suspension system, the body-posture-change suppressing control is executed, in addition to the sprung-vibration damping control, for mitigating the roll of the vehicle body generated arising from turning of the vehicle and the pitch of the vehicle body generated arising from acceleration and deceleration of the vehicle. In the body-posture-change suppressing control, the actuator 250 generates a force against the roll moment that acts on the vehicle body as a cause of the roll of the vehicle body and a force against the pitch moment that acts on the vehicle body as a cause of the pitch of the vehicle body.

For mitigating the roll of the vehicle body, the body-posture-change suppressing control is executed as follows. Each of the actuators 250 of the respective two suspension devices 220 located on the inner side of the turning path of the vehicle is controlled to generate, in accordance with the roll moment, the actuator force in a direction in which the sprung portion and the unsprung portion move toward each other (hereinafter referred to as “bound direction” where appropriate), and each of the actuators 250 of the respective two suspension devices 220 located on the outer side of the turning path of the vehicle is controlled to generate, in accordance with the roll moment, the actuator force in a direction in which the sprung portion and the unsprung portion move away from each other (hereinafter referred to as “rebound direction” where appropriate). Each actuator force is generated as a roll suppressing component F_{R}, which is one sort of a posture-change suppressing component.

Specifically, the control lateral acceleration Gy* is determined according to the following expression by a technique similar to that in the stabilizer system described above based on i) the estimated lateral acceleration Gy_{E} obtained based on the operation amount δ of the steering wheel 16 and the vehicle speed v and ii) the actual lateral acceleration Gy_{R} detected by the lateral acceleration sensor 198.

$$\begin{matrix}{\text{Gy}}^{*} = {\text{K}}_{\text{E}} ⋅ {\text{Gy}}_{\text{E}} {\text{+K}}_{\text{R}} ⋅ {\text{Gy}}_{\text{R}} & \left({\text{K}}_{\text{E}} , {\text{K}}_{\text{R}} \text{: weighting coefficients}\right)\end{matrix}$$

The thus determined control lateral acceleration Gy* is a roll-moment index amount indicative of the roll moment that acts on the vehicle body. Based on the control lateral acceleration Gy*, the roll suppressing component F_{R} is determined according to the following expression:

$$\begin{matrix}{\text{F}}_{\text{R}} {\text{=K}}_{\text{Y}} ⋅ {\text{Gy}}^{\text{*}} & \left({\text{K}}_{\text{Y}} \text{: roll suppression gain}\right)\end{matrix}$$

The roll suppressing component F_{R} is one component of the actuator force. The roll suppressing component F_{R} is the control subject of the actuator 250. Further, the lateral acceleration Gy is a factor that causes the posture of the vehicle 10 to be changed. The suspension ECU 370 determines the roll suppressing component F_{R} as the target value of the control subject based on the lateral acceleration Gy, which is a factor that causes the posture of the vehicle 10 to be changed.

For mitigating the pitch of the vehicle body, the body-posture-change suppressing control is executed as follows. For nose dive of the vehicle body generated upon braking of the vehicle body, each of the actuators 250 of the respective two front-wheel-side suspension devices 220 is controlled to generate, in accordance with the pitch moment, the actuator force in the rebound direction, and each of the actuators 250 of the respective two rear-wheel-side suspension devices 220 is controlled to generate, in accordance with the pitch moment, the actuator force in the bound direction. Each actuator force is generated as a pitch suppressing component F_{P}. For squat of the vehicle body generated upon acceleration of the vehicle body, each of the actuators 250 of the respective two rear-wheel-side suspension devices 220 is controlled to generate, in accordance with the pitch moment, the actuator force in the rebound direction, and each of the actuators 250 of the respective two front-wheel-side suspension devices 220 is controlled to generate, in accordance with the pitch moment, the actuator force in the bound direction. Each actuator force is generated as the pitch suppressing component F_{P}, which is one sort of the posture-change suppressing component.

Specifically, the actual longitudinal acceleration Gx detected by the longitudinal acceleration sensor 384 is employed as the pitch-moment index amount indicative of the pitch moment, and the pitch suppressing component F_{P} is determined based on the actual longitudinal acceleration Gx according to the following expression:

$$\begin{matrix}{\text{F}}_{\text{P}} {\text{=K}}_{\text{X}} ⋅ {\text{G}}_{\text{X}} & \left({\text{K}}_{\text{X}} \text{: pitch suppression gain}\right)\end{matrix}$$

The pitch suppressing component F_{P} is also one component of the actuator force. The pitch suppressing component F_{P} is the control subject of the actuator 250. Further, the longitudinal acceleration Gx is also a factor that causes the posture of the vehicle 10 to be changed. The suspension ECU 370 determines the pitch suppressing component F_{P} as the target value of the control subject based on the longitudinal acceleration Gx, which is a factor that causes the posture of the vehicle 10 to be changed.

### III) Synthesizing of Two Controls

The sprung-vibration damping control and the body-posture-change suppressing control described above are synthetically executed, and the sprung-vibration damping component F_{U}, the roll suppressing component F_{R}, and the pitch suppressing component F_{P} in the controls are dealt with in a unified way. Specifically, those components F_{U}, F_{R}, F_{P} are summed up according to the following expression to determine a synthetic actuator force F to be generated by the actuator 250.

$${\text{F=F}}_{\text{U}} {\text{+F}}_{\text{R}} {\text{+F}}_{\text{P}}$$

The actuator force F in which those components F_{U}, F_{R}, F_{P} are synthesized is the actuator force to be generated by each of the actuators 250 of the respective four suspension devices 220. The operation of the electric motor 276 of each actuator 250 is controlled to generate the actuator force. Specifically, the actuator force F being generated and the current being supplied to the electric motor 276 of the actuator 250 are generally proportional relative to each other. The suspension ECU 370 determines the supply current I_{S} that should be supplied to the electric motor 276 of each actuator 250 based on the actuator force F that should be generated by the actuator 250 and supplies the current to the electric motor 276 via the inverter based on the determined supply current I_{S}.

### IV) Current Reduction Process

The current reduction process is executed also in the present suspension system. Specifically, the current reduction process is executed in the specific situation on the supply current to the actuator 250, namely, the supply current to the electric motor 276, in consideration of power and energy saving. The current reduction process executed in the present suspension system will be hereinafter described.

Like the steering ECU 20 of the steering system and the stabilizer ECU 140 of the stabilizer system described above, the suspension ECU 370 of the present suspension system identifies that the vehicle 10 is in the specific situation and executes the current reduction process when the vehicle speed v of the vehicle 10 is not higher than the threshold vehicle speed V_{TH}, e.g., 20-30 km/h, and when the vehicle 10 is performing automated driving, in consideration of the response of the actuator 250, etc.

In the present suspension system, the current reduction process is executed not on the sprung-vibration damping component F_{U} but only on the posture-change suppressing components, i.e., the roll suppressing component F_{R} and the pitch suppressing component F_{P}. Further, the gain reduction process executed in the steering system described above is not executed in the present suspension system, but only the low-pass filtering process is executed on the target motion amount of the actuator. That is, the low-pass filtering process is executed only on the roll suppressing component F_{R} and the pitch suppressing component F_{P}. It is, however, noted that the low-pass filtering process is executed only in the specific situation and is not executed when the vehicle 10 is not in the specific situation. Further, in the present suspension system, the cutoff frequency f_{C} in the low-pass filtering process is neither changed based on the traveling mode nor gradually changed depending on the vehicle speed v. That is, the low-pass filtering process, in which the cutoff frequency f_{C} is fixed at the low frequency f_{CL1}, is executed on the roll suppressing component F_{R} and the pitch suppressing component F_{P} only in the specific situation. The current reduction process thus executed in the present suspension system adequately achieves power and energy saving.

As executed in the steering system described above, the low-pass filtering process may be executed with the cutoff frequency f_{C} set at a high frequency even when the vehicle 10 is not in the specific situation. Further, as executed in the steering system described above, the low-pass filtering process may be executed such that the cutoff frequency f_{C} is changed depending on the vehicle speed v and the traveling mode.

In the steering system described above, the functions of the steering ECU 20, which is the controller, are explained referring to the block diagram. The functions of the suspension ECU 370 of the present suspension system, which is the controller, can be easily estimated based on the functions of the steering ECU 20, and a description of the functions of the suspension ECU 370 referring to a block diagram is dispensed with.

### V) Control Flow

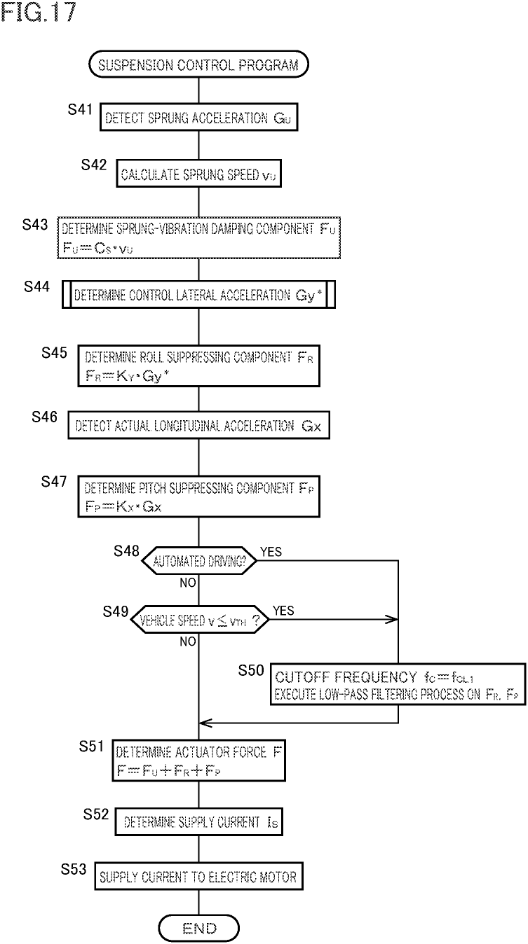

The computer of the suspension ECU 370 repeatedly executes a suspension control program represented by a flowchart of FIG. 17 at a short time pitch of from several to several tens of milliseconds, for instance, so that the control of the actuator 250 described above is executed. The flow of processing according to the suspension control program will be briefly described referring to the flowchart.

The processing according to the suspension control program starts with S41 at which the sprung acceleration Gu is detected by the sprung vertical acceleration sensor 386. At S42, the sprung speed vu is calculated based on the sprung acceleration Gu. At S43, the sprung-vibration damping component F_{U} is determined based on the sprung speed vu and the damping coefficient Cs of the skyhook damper.

At S44, the control lateral acceleration Gy* is determined. The control lateral acceleration Gy* is determined according to a process similar to the process of S21-S25 in the stabilizer control program. At S45, the roll suppressing component F_{R} is determined based on the control lateral acceleration Gy*. At S46, the longitudinal acceleration Gx is detected by the longitudinal acceleration sensor 384. At S47, the pitch suppressing component F_{P} is determined based on the detected longitudinal acceleration Gx.

It is then determined at S48 whether the vehicle 10 is performing automated driving. When the vehicle 10 is performing manual driving, it is determined at S49 whether the vehicle speed v is not higher than the threshold vehicle speed V_{TH}. When it is determined at S48 that the vehicle 10 is performing automated driving or when it is determined at S49 that the vehicle speed v is not higher than the threshold vehicle speed V_{TH}, the control flow proceeds to S50 to execute, on the roll suppressing component F_{R} and the pitch suppressing component F_{P}, the low-pass filtering process in which the cutoff frequency f_{C} is set at the low frequency f_{CL1s}.

The control flow then proceeds to S51 to sum up i) the sprung-vibration damping component F_{U} and ii) the roll suppressing component F_{R} and the pitch suppressing component F_{P} on which the low-pass filtering process has been or has not been executed, so as to determine a synthetic actuator force F to be generated. At S52, the supply current I_{S}, which is a current to be supplied to the electric motor 276 of the actuator 250, is determined based on the actuator force F. At S53, the supply current I_{S} is supplied to the electric motor 276 via the inverter. Thus, one execution of the suspension control program is ended.

What is claimed is:

1. A vehicle behavior control system, comprising:
an electric actuator mounted on a vehicle to change a posture of the vehicle; and
a controller configured to control, as a control subject, one of a motion amount of the electric actuator and a force generated by the electric actuator,
wherein the controller is configured to:
determine a target value of the control subject based on i) the posture that the vehicle should take, ii) a factor that causes the posture of the vehicle to be changed, or iii) both the posture that the vehicle should take and the factor that causes the posture of the vehicle to be changed;
supply a current to the electric actuator based on the target value; and
execute, in a specific situation, a current reduction process of reducing the current to be supplied to the electric actuator.

2. The vehicle behavior control system according to claim 1, wherein the specific situation is a situation in which a high response is not required for a motion of the electric actuator.

3. The vehicle behavior control system according to claim 1, wherein the specific situation is a situation in which a traveling speed of the vehicle is not higher than a set speed.

4. The vehicle behavior control system according to claim 1,
wherein the vehicle is capable of performing both manual driving by a driver and automated driving, and
wherein the specific situation is a situation in which the vehicle is performing the automated driving.

5. The vehicle behavior control system according to claim 1,
wherein the controller executes the current reduction process such that the controller executes a low-pass filtering process on the target value only in the specific situation or such that the controller lowers a cutoff frequency in the low-pass filtering process executed on the target value to a greater extent in the specific situation than not in the specific situation.

6. The vehicle behavior control system according to claim 1,
wherein the controller is configured to:
supply the current to the electric actuator by a feedback control based on a deviation of an actual value of the control subject with respect to the target value of the control subject; and
execute the current reduction process such that the controller reduces a gain in the feedback control to a greater extent in the specific situation than not in the specific situation.

7. The vehicle behavior control system according to claim 1,
wherein the electric actuator is a steering actuator configured to steer a wheel, and
wherein the vehicle behavior control system is a steering system.

8. The vehicle behavior control system according to claim 1,
wherein the vehicle is equipped with a stabilizer bar connected at opposite ends thereof respectively to a right wheel and a left wheel to suppress a roll of a body of the vehicle,
wherein the electric actuator is an actuator configured to change a roll suppressing force generated by the stabilizer bar, and
wherein the vehicle behavior control system is an active stabilizer system.

9. The vehicle behavior control system according to claim 1,
wherein the electric actuator is an actuator to exert a force on a relative movement of the wheel and a body of the vehicle in an up-down direction, and
wherein the vehicle behavior control system is an active suspension system.
